(19) United States
(12) Patent Application Publication
(10) Pub. No.: US 2026/0273408 A1
(43) Pub. Date: Sep. 17, 2026

(54) METHOD AND APPARATUS FOR SUMMONING VIRTUAL PET, DEVICE, AND STORAGE MEDIUM

(71) Applicant: Tencent Technology (Shenzhen) Company Limited, Shenzhen (CN)

(72) Inventor: Xiusheng SONG, Shenzhen (CN)

(21) Appl. No.: 19/667,457

(22) Filed: May 4, 2026

Related U.S. Application Data
(63) Continuation of application No. PCT/CN2025/104449, filed on Jun. 27, 2025.

(30) Foreign Application Priority Data
Aug. 7, 2024 (CN) 202411080391.2

(51) Int. Cl. A63F 13/55; A63F 13/42; A63F 13/52; A63F 13/5372

(52) U.S. Cl. CPC A63F 13/55; A63F 13/42; A63F 13/52; A63F 13/5372

(57) ABSTRACT

This application provides a method for summoning a virtual minion performed by a computer device. The method includes: displaying, in a graphical user interface, a primarily controlled virtual character in a virtual environment and at least one element card; in response to a selection operation for a first element card, generating a position cursor near a first position in the virtual environment, the first position being a summoning position of the virtual minion in the virtual environment; in response to a trigger operation for the first element card, summoning the virtual minion at the first position in the virtual environment, an element attribute of the virtual minion being consistent with an element attribute identifier of the first element card; and displaying an animation in which the primarily controlled virtual character throws out the first element card toward the first position in the virtual environment.

### CROSS-REFERENCE TO RELATED APPLICATIONS

This application is a continuation application of PCT Patent Application No. PCT/CN2025/104449, entitled “METHOD AND APPARATUS FOR SUMMONING VIRTUAL PET, DEVICE, AND STORAGE MEDIUM” filed on Jun. 27, 2025, which claims priority to Chinese Patent Application No. 202411080391.2, entitled " METHOD AND APPARATUS FOR SUMMONING VIRTUAL PET, DEVICE, AND STORAGE MEDIUM " filed on Aug. 7, 2024, all of which are incorporated herein by reference in their entirety.

### FIELD OF THE TECHNOLOGY

This application relates to the field of human-computer interaction technologies, and to a method and an apparatus for summoning a virtual minion, a device, and a storage medium.

### BACKGROUND OF THE DISCLOSURE

With the development of computer technologies, a virtual environment provides a space for a virtual character to perform a virtual activity, and types of articles and characters in the virtual environment are diverse.

In the related art, a user controls a primarily controlled virtual character to perform a virtual activity, and a virtual minion is further provided in the virtual environment. The user may further configure, based on identity information of the virtual minion, a virtual minion that needs to enter a field in the virtual environment, and the virtual minion performs the virtual activity along with the primarily controlled virtual character.

However, because the primarily controlled virtual character owns a plurality of virtual minions, the virtual minion to enter a field cannot be quickly determined based on the identity information, so that efficiency of human-computer interaction is low.

### SUMMARY

This application provides a method and an apparatus for summoning a virtual minion, a device, and a storage medium. The technical solutions are as follows:

According to an aspect of this application, a method for summoning a virtual minion is performed by a computer device, e.g., a terminal. The method includes:

displaying, in a graphical user interface, a primarily controlled virtual character in a virtual environment and at least one element card;

in response to a selection operation for a first element card, generating a position cursor near a first position in the virtual environment, the first position being a summoning position of the virtual minion in the virtual environment;

in response to a trigger operation for the first element card, summoning the virtual minion at the first position in the virtual environment, an element attribute of the virtual minion being consistent with an element attribute identifier of the first element card; and

displaying an animation in which the primarily controlled virtual character throws out the first element card toward the first position in the virtual environment.

According to another aspect of this application, a computer device is provided. The computer device includes a processor and a memory. The memory stores at least one instruction, at least one program, a code set, or an instruction set. The at least one instruction, the at least one program, the code set, or the instruction set is loaded and executed by the processor to implement the method for summoning a virtual minion according to the above aspect.

According to another aspect of this application, a non-transitory computer-readable storage medium is provided. The readable storage medium stores at least one instruction, at least one program, a code set, or an instruction set. The at least one instruction, the at least one program, the code set, or the instruction set, when executed by a processor of a computer device, causing the computer device to implement the method for summoning a virtual minion according to the above aspect.

Beneficial effects brought by the technical solutions provided in this application at least include:

An element attribute identifier is displayed on a virtual card, and an element attribute of a summoned virtual minion is indicated through the element attribute identifier, to provide a human-computer interaction way a virtual minion to enter a field is summoned through a selection operation and a trigger operation for an element card. The element attribute identifier is displayed on the virtual card, a problem in the related art is prevented in which, in the event of a plurality of types of virtual minions, the element attribute of the virtual minion cannot be directly presented by displaying an identity identifier of the virtual minion, and as an increase in the types of the virtual minions, a quantity of identity identifiers needing to be displayed increases and a player needs to memorize a relatively large quantity of identity identifiers, thereby increasing complexity for the player to distinguish the element attributes of the virtual minions. In this way, efficiency of human-computer interaction for summoning a virtual minion is improved.

### BRIEF DESCRIPTION OF THE DRAWINGS

FIG. 1 is a structural block diagram of a computer system according to an exemplary embodiment of this application.

FIG. 2 is a schematic diagram of a method for summoning a virtual minion according to an exemplary embodiment of this application.

FIG. 3 is a flowchart of a method for summoning a virtual minion according to an exemplary embodiment of this application.

FIG. 4 is a flowchart of a method for summoning a virtual minion according to an exemplary embodiment of this application.

FIG. 5 is a schematic diagram of an entrance animation of a virtual minion according to an exemplary embodiment of this application.

FIG. 6 is a schematic diagram of an entrance animation of a virtual minion according to an exemplary embodiment of this application.

FIG. 7 is a schematic diagram of a throwing animation according to an exemplary embodiment of this application.

FIG. 8 is a flowchart of a method for summoning a virtual minion according to an exemplary embodiment of this application.

FIG. 9 is a flowchart of a method for summoning a virtual minion according to an exemplary embodiment of this application.

FIG. 10 is a schematic diagram of a virtual environment according to an exemplary embodiment of this application.

FIG. 11 is a schematic diagram of a fused virtual minion according to an exemplary embodiment of this application.

FIG. 12 is a structural block diagram of an apparatus for summoning a virtual minion according to an exemplary embodiment of this application.

FIG. 13 is a structural block diagram of a terminal according to an exemplary embodiment of this application.

### DESCRIPTION OF EMBODIMENTS

To make objectives, technical solutions, and advantages of this application clearer, implementations of this application are further described in detail below with reference to the accompanying drawings.

Exemplary embodiments are described herein in detail, and examples of the exemplary embodiments are shown in the accompanying drawings. When the following description involves the accompanying drawings, unless otherwise indicated, the same numerals in different accompanying drawings represent the same or similar elements. The implementations described in the following exemplary embodiments do not represent all implementations consistent with this application. On the contrary, the implementations are merely examples of an apparatus and a method that are consistent with some aspects of this application as detailed in the appended claims.

Terms used in the present disclosure are for the purpose of describing specific embodiments only and are not intended to limit the present disclosure. Terms "a", "the", and "said" in a singular form used in the present disclosure and the appended claims are also intended to include a plural form, unless otherwise specified in the context clearly. A term "and/or" used herein indicates and includes any or all combinations of one or more associated listed items.

User information (including but not limited to user device information and user personal information) and data (including but not limited to data for analysis, stored data, and displayed data) involved in this application are all information and data authorized by users or fully authorized by all parties, and collection, use, and processing of relevant data need to comply with relevant laws, regulations, and standards of relevant countries and regions. For example, information for a selection operation for a first element card, a trigger operation for the first element card, or the like involved in this application is obtained under full authorization.

Although terms such as "first" and "second" may be used in the present disclosure to describe various information, the information is not limited to these terms. These terms are merely used to distinguish between information of the same type. For example, without departing from a scope of the present disclosure, a first parameter may also be referred to as a second parameter, and similarly, the second parameter may also be referred to as the first parameter. Depending on the context, for example, a word "if" used herein may be interpreted as "when", "when", or "in response to determination".

Virtual environment: This is a virtual environment displayed (or provided) when an application program runs on a terminal. The virtual environment may be a simulated environment for the real world, a semi-simulated and semi-fictitious virtual environment, or a purely fictitious virtual environment. The virtual environment may be any one of a two-dimensional virtual environment, a 2.5-dimensional virtual environment, or a three-dimensional virtual environment. The embodiments of this application do not limit the dimension of the virtual environment. For example, the virtual environment may include sky, land, ocean, or the like, and the land may include environmental elements, such as a desert and a city. A user may control a virtual character to move in the virtual environment.

Virtual character: It refers to a movable object in the virtual environment. The movable object may be a virtual person, a virtual animal, an animated character, or the like, for example, a person, an animal, a plant, an oil drum, a wall, or a stone block displayed in the virtual environment. The virtual character may be a virtual image in the virtual environment for representing the user. The virtual environment may include a plurality of virtual characters, and each of the virtual characters has a shape and a volume thereof in the virtual environment and occupies a part of space in the virtual environment. In some embodiments, when the virtual environment is a three-dimensional virtual environment, the virtual character is a three-dimensional stereoscopic model, and the three-dimensional solid model is a three-dimensional character constructed based on a three-dimensional human skeleton technology. The same virtual character presents different external images by wearing different skins. In some embodiments, the virtual character may also be implemented by using a 2.5-dimensional model or a 2-dimensional model, which is not limited in the embodiments of this application. In some embodiments, the virtual character may be a player character controlled through an operation on a client, or may be a non-player character (NPC) provided for interaction in the virtual environment.

Virtual minion: It refers to a character that follows a primarily controlled virtual character or completes a virtual activity through cooperation with the primarily controlled virtual character in the virtual environment. The pet character has an autonomous behavior capability and performs the virtual activity in the virtual environment. For example, types of application programs providing the virtual environment are different. In the application programs, the virtual minion is also referred to as at least one of a virtual phantasmic beast, a virtual strange beast, a virtual mount, or a virtual raised pet. This application does not limit the name of the virtual minion in the application programs.

Element attribute: A virtual minion may possess an element attribute. The element attribute is configured for indicating a category of virtual power of the virtual minion. The virtual minion may use the possessed element attribute to generate a positive additive effect on a performed virtual activity (for example, using a virtual electricity element to add an endurance period for a vehicle using virtual electric power), and/or generate resistance to the possessed element attribute, so as to prevent virtual damage caused by the element attribute (for example, preventing virtual lightning strike damage caused by the virtual electricity element).

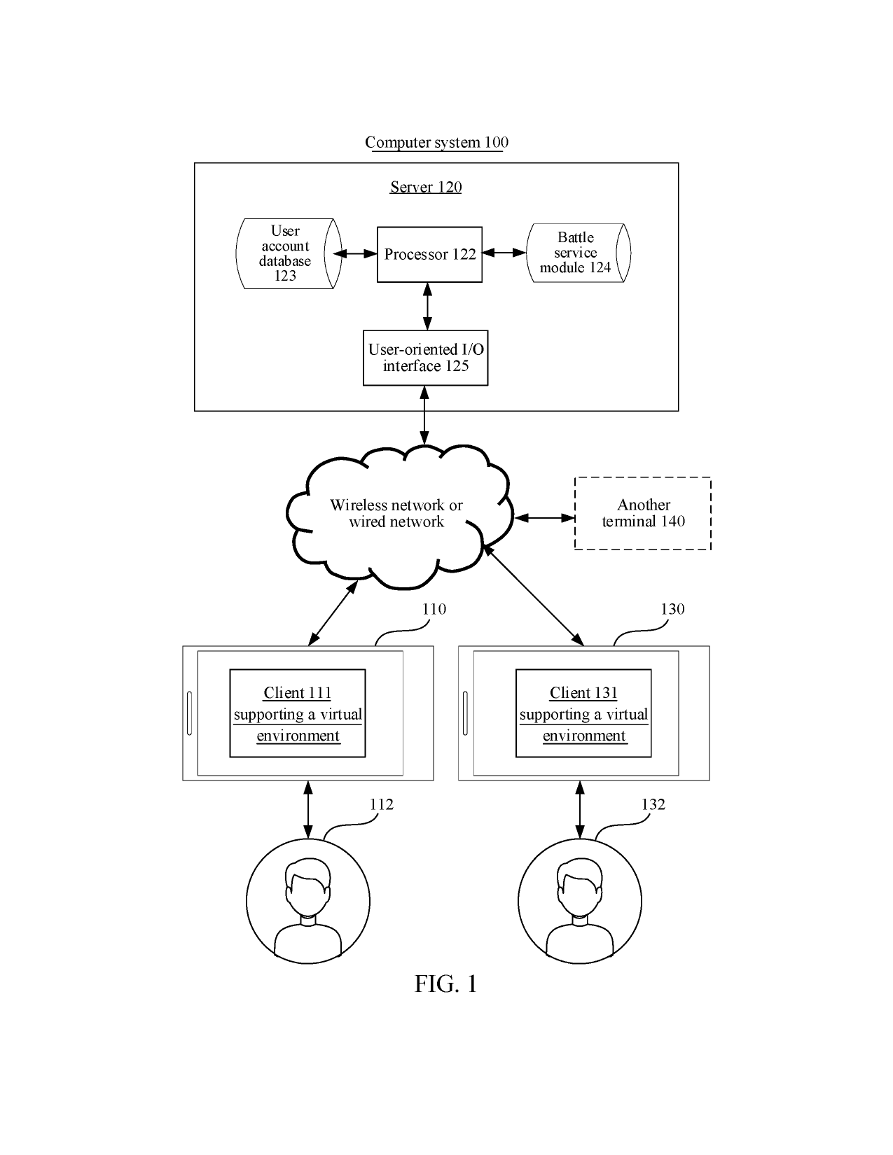

FIG. 1 shows a structural block diagram of a computer system according to an exemplary embodiment of this application. The computer system 100 includes a first terminal 110, a server 120, and a second terminal 130.

The first terminal 110 has a client 111 supporting a virtual environment installed and running therein. The client 111 may be a multiplayer online battle program. When the first terminal runs the client 111, a user interface of the client 111 is displayed on a screen of the first terminal 110. The client 111 may be any one of a battle royale shooting game, a virtual reality (VR) application program, an augmented reality (AR) program, a three-dimensional map program, a VR game, an AR game, a casual game, a party gathering game, a first-person shooting game (FPS), a third-personal shooting game (TPS), a multiplayer online battle arena game (MOBA), and a simulation game (SLG). In this embodiment, an example in which the client 111 is an FPS game is used for description. The first terminal 110 is a terminal used by a first user 112, and the first user 112 uses the first terminal 110 to control a first virtual object located in the virtual environment to perform an activity. The first virtual object may be referred to as a virtual object of the first user 112. The activity of the first virtual object includes, but is not limited to, at least one of moving, jumping, transporting, releasing a skill, using a prop, adjusting a body pose, crawling, walking, running, riding, flying, jumping, driving, picking up, shooting, attacking, or throwing. For example, the first virtual object is at least one of a simulated character, a cartoon character, a virtual animal, or a virtual plant.

The second terminal 130 has a client 131 supporting a virtual environment installed and running therein. The client 131 may be a multiplayer online battle program. When the second terminal 130 runs the client 131, a user interface of the client 131 is displayed on a screen of the second terminal 130. The client may be any one of a battle royale shooting game, a VR application program, an AR program, a three-dimensional map program, a VR game, an AR game, an FPS, a TPS, a MOBA, or an SLG. In this embodiment, an example in which the client is a MOBA game is used for description. The second terminal 130 is a terminal used by a second user 132, and the second user 132 uses the second terminal 130 to control a second virtual object located in the virtual environment to perform an activity. The second virtual object may be referred to as a virtual object of the second user 132. Similarly, for example, the second virtual character is at least one of a simulated character, a cartoon character, a virtual animal, or a virtual plant. In some embodiments, the first virtual object and the second virtual object are in the same virtual environment. In some embodiments, the first virtual object and the second virtual object may belong to the same camp, the same team, or the same organization, may be friends, or may have a temporary communication permission. In some embodiments, the first virtual object and the second virtual object may belong to different camps, different teams, or different organizations, or may be rivals.

In some embodiments, clients installed in the first terminal 110 and the second terminal 130 are the same, or the clients installed in the two terminals are clients of the same type on different operating system platforms (Android or IOS). The first terminal 110 may refer to one of a plurality of terminals, and the second terminal 130 may refer to another of the plurality of terminals. In this embodiment, only the first terminal 110 and the second terminal 130 are used as an example for description. Device types of the first terminal 110 and the second terminal 130 are the same or different. The device type includes at least one of a smartphone, a tablet computer, an e-book reader, an MP3 player, an MP4 player, a laptop portable computer, or a desktop computer.

FIG. 1 shows only two terminals. However, in different embodiments, a plurality of other terminals 140 exist and may be connected to the server 120. In some embodiments, one or more terminals 140 corresponding to a developer further exist. A development and editing platform supporting a client of a virtual environment is installed on each of the terminals 140. The developer may edit and update the client on the terminals 140 and transmit the updated client installation package to the server 120 through a wired network or a wireless network. The first terminal 110 and the second terminal 130 may download a client installation package from the server 120 to update the client.

The first terminal 110, the second terminal 130, and the other terminals 140 are connected to the server 120 through the wired network or the wireless network. The server 120 includes at least one of the following: one server, a plurality of servers, a cloud computing platform, or a virtualization center. The server 120 is configured to provide a backend service for a client supporting a three-dimensional virtual environment. In some embodiments, the server 120 is responsible for primary computing work, and the terminal is responsible for secondary computing work. Alternatively, the server 120 is responsible for secondary computing work, and the terminal is responsible for primary computing work. Alternatively, a distributed computing architecture is adopted for collaborative computing between the server 120 and the terminal.

In an exemplary example, the server 120 includes a processor 122, a user account database 123, a battle service module 124, and a user-oriented input/output (I/O) interface 125. The processor 122 is configured to load instructions stored in the server 120 and process data in the user account database 123 and the battle service module 124. The user account database 123 is configured to store data of a user account used by the first terminal 110, the second terminal 130, and the other terminals 140, for example, an avatar of the user account, a nickname of the user account, a combat effectiveness index of the user account, and a service area where the user account is located. The battle service module 124 is configured to provide a plurality of battle rooms for users to battle, for example, a 1V1 battle, a 3V3 battle, and a 5V5 battle. The user-oriented I/O interface 125 is configured to establish communication with the first terminal 110 and/or the second terminal 130 through a wireless network or a wired network to exchange data.

The method provided in this application may be, but not limited to, applied to at least one of the following scenarios: a VR application program, a three-dimensional map program, a casual game, a party gathering game, an FPS, a TPS, a MOBA, and a multiplayer gunfight survival game. The following embodiments are described using an application in a game as an example.

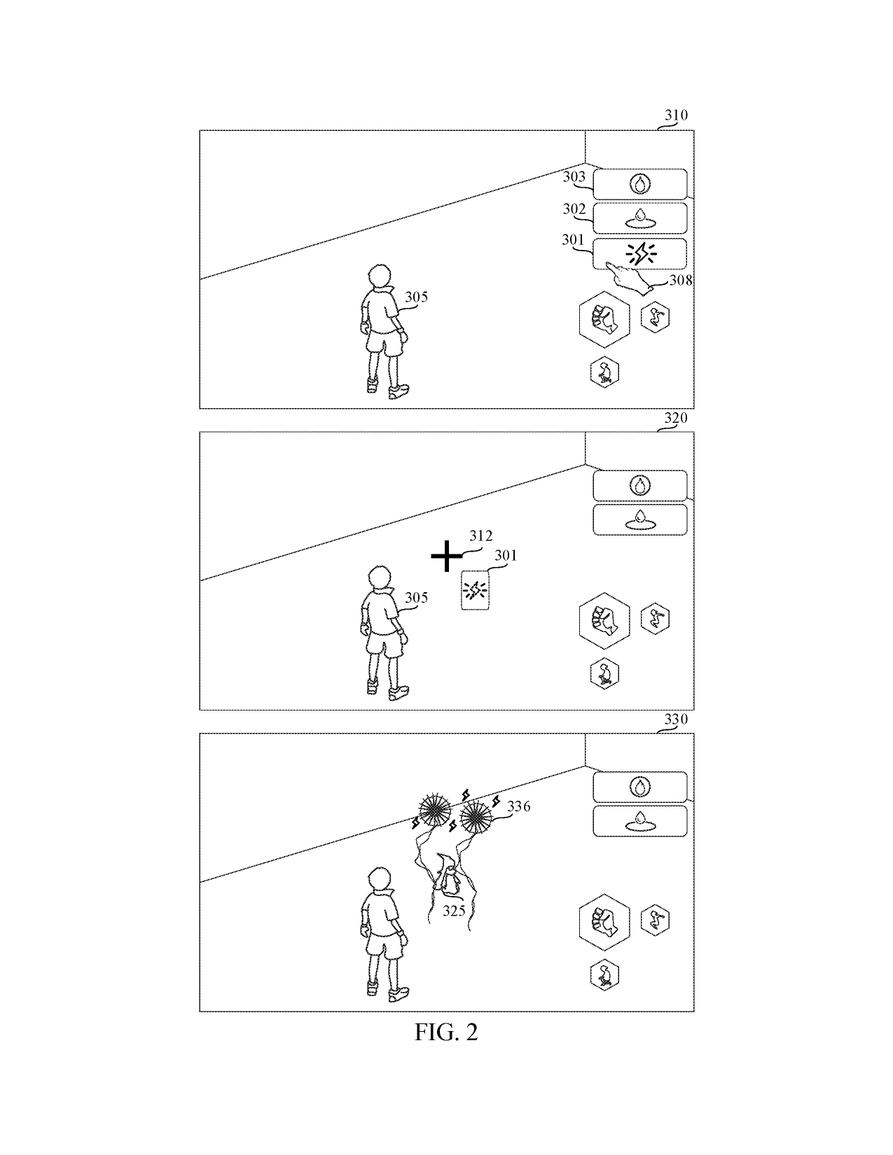

FIG. 2 shows a schematic diagram of a method for summoning a virtual minion according to an exemplary embodiment of this application.

On a first interface 310, a primarily controlled virtual character 305 in a virtual environment, and three element cards are displayed. In different examples, more or fewer element cards may be displayed. In this embodiment, the first interface 310 includes a first element card 301, a second element card 302, and a third element card 303. The first element card 301 includes an element attribute identifier of a virtual electricity element attribute, and the element attribute identifier includes a pattern in a thunderbolt shape. The second element card 302 includes an element attribute identifier of a virtual water element attribute, and the element attribute identifier includes a pattern in a water-drop shape. The third element card 303 includes an element attribute identifier of a virtual fire element attribute, and the element attribute identifier includes a pattern in a flame shape.

A second interface 320 is displayed in response to a touch and hold operation 308 for the first element card 301. A position cursor 312 is displayed on the second interface 320, and the position cursor 312 is located at a central point of the second interface 320. For example, when the touch and hold operation 308 is maintained, a position in a virtual environment to which the position cursor 312 points is adjusted by adjusting a position of a primarily controlled virtual character 305 in the virtual environment or adjusting a perspective of the primarily controlled virtual character 305. On the second interface 320, a display position of the first element card 301 is switched from being arranged in parallel with other element cards (the second element card 302 and the third element card 303) to being displayed on a peripheral side of the position cursor 312. For example, on the second interface 320, a transparency degree of the first element card 301 is increased, and the first element card 301 is displayed as being semitransparent.

In response to a release operation for the first element card 301, the touch and hold operation 308 for the first element card 301 is no longer maintained, and a third interface 330 is displayed. The third interface 330 presents that a virtual minion 325 is summoned at a first position in the virtual environment. The virtual minion 325 has a virtual electricity element attribute, and the virtual electricity element attribute is consistent with the element attribute identifier on the first element card 301. For example, on the third interface 330, a thunderbolt effect 336 is further displayed on a peripheral side of the virtual minion 325.

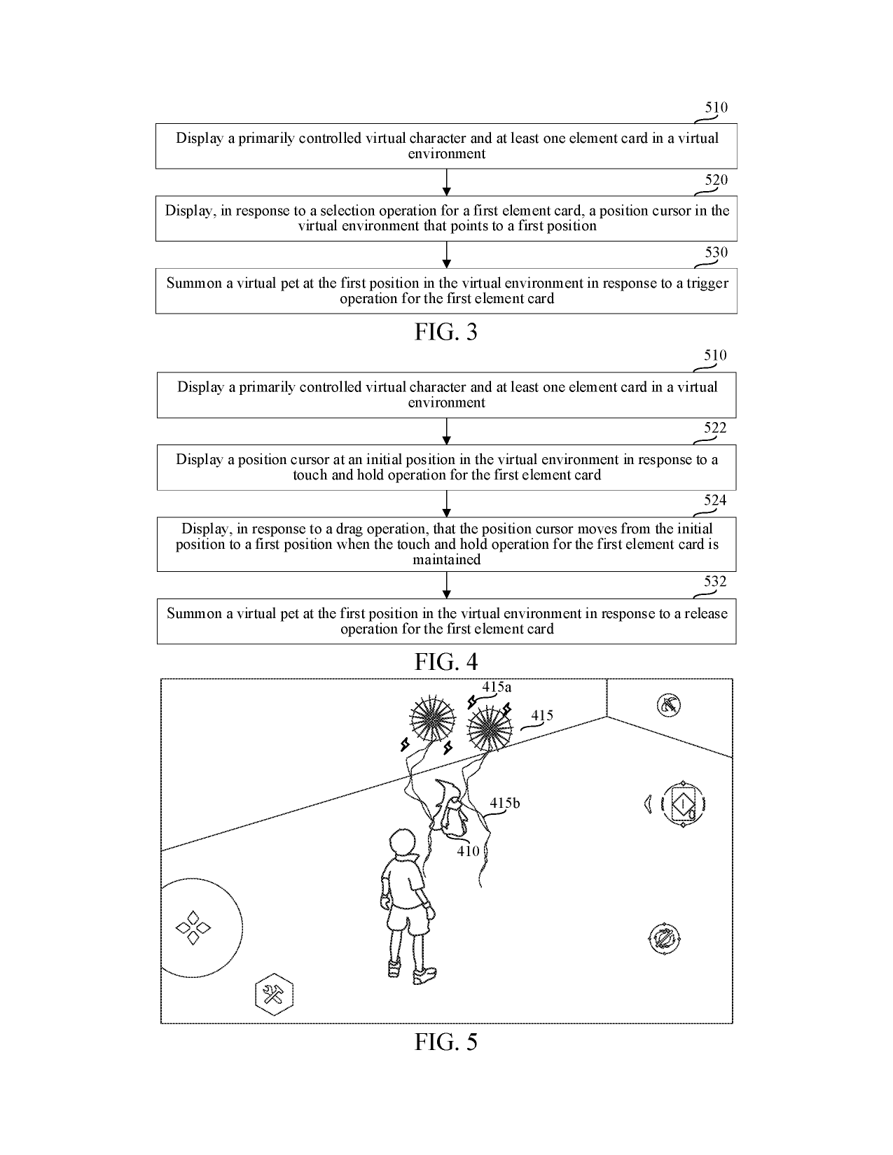

FIG. 3 shows a flowchart of a method for summoning a virtual minion according to an exemplary embodiment of this application. The method may be performed by a computer device. The method includes:

Operation 510: Display, in a graphical user interface, a primarily controlled virtual character in a virtual environment and at least one element card.

For example, the virtual environment is a virtual space for at least one virtual character to perform a virtual activity. For example, a first virtual character implements virtual competition by initiating a virtual attack in a virtual battle, or constructs a virtual building and manufactures a virtual article in the virtual environment to maintain virtual survival. The virtual environment may be any one of a two-dimensional virtual environment, a 2.5-dimensional virtual environment, and a three-dimensional virtual environment. For example, the primarily controlled virtual character is a virtual character directly controlled by a user in the virtual environment. The element card is a card possessed by the primarily controlled virtual character controlled by the user. A first element card in the at least one element card includes an element attribute identifier. The element attribute identifier presents an element attribute corresponding to the first element card through at least one of the following modes: a text, a symbol, a picture, an animated image, or the like. In an example, the element card may always be displayed when a player controls the primarily controlled virtual character to perform a virtual activity, or may be triggered and displayed when the player intends to summon a virtual minion. For example, a summoning control for a virtual minion is displayed, and at least one element card is displayed in response to a trigger operation for the summoning control. For example, a quantity of the at least one element card displayed on an interface does not exceed a quantity threshold (for example, not exceeding three). When the primarily controlled virtual character has a larger quantity of element cards, a currently displayed element card is switched to display another element card through a sliding operation (for example, sliding in a vertical direction) on a display region where the at least one element card is located.

Operation 520: In response to a selection operation for the first element card, generate and display a position cursor near a first position in the virtual environment. The first position is a summoning position of the virtual minion in the virtual environment.

For example, in response to the selection operation for the first element card, an intention to use the first element card to summon a virtual minion occurs. The first position is a summoning position of the virtual minion in the virtual environment, and the position cursor is configured for indicating the summoning position of the virtual minion in the virtual environment. For example, the position cursor may be displayed on a base plane of the virtual environment, for example, on a virtual ground of the virtual environment, to indicate the summoning position of the virtual minion in the virtual environment. The position cursor may also be displayed on a superimposed layer (also referred to as a heads-up display (HUD) layer) in an HUD mode. The HUD is a picture for displaying related information in the virtual environment and is usually displayed on an upper layer of an observation picture of the virtual environment.

Operation 530: Summon, in response to a trigger operation for the first element card, the virtual minion at the first position in the virtual environment.

For example, in response to the trigger operation for the first element card, an intention to summon a virtual minion in the virtual environment occurs. The virtual minion is summoned at the first position in the virtual environment, and an element attribute of the virtual minion is consistent with the element attribute identifier. The virtual minion has the element attribute, and the element attribute of the virtual minion includes one or more element attributes corresponding to element attribute identifiers on the first element card. In an example, the element attribute includes at least one of a virtual electricity element attribute, a virtual fire element attribute, a virtual water element attribute, a virtual soil element attribute, a virtual metal element attribute, a virtual illumination element attribute, or a virtual dark element attribute. For example, the element attribute of the virtual minion may include one or more. That the element attribute of the virtual minion is consistent with the element attribute identifier is only used for defining that an intersection set of the element attribute of the virtual minion and one or more element attributes corresponding to the element attribute identifiers is not empty, not that the two are entirely the same.

For example, the element attribute of the virtual minion is configured for indicating a category of virtual power of the virtual minion. Using an example in which a virtual minion has a virtual fire element attribute, a virtual skill or a virtual attribute of the virtual minion is associated with the virtual fire element attribute. For example, the virtual skill or the virtual attribute of the virtual minion has a high-temperature characteristic. For example, a virtual minion possessed by a primarily controlled virtual character may be captured in the virtual environment, purchased in the virtual environment, obtained through drawing from a virtual prize pool, raised in the virtual environment, or reproduced in the virtual environment. This application does not limit a manner to obtain the virtual minion.

Based on the above, according to the method provided in this embodiment, an element attribute identifier is displayed on a virtual card, and an element attribute of a summoned virtual minion is indicated through the element attribute identifier, so as to provide a human-computer interaction manner in which a virtual minion to enter a field is summoned through a selection operation and a trigger operation for an element card. The element attribute identifier is displayed on the virtual card, a problem in the related art is prevented in which, in the event of a plurality of types of virtual minions, the element attribute of the virtual minion cannot be directly presented by displaying an identity identifier of the virtual minion, and as an increase in the types of the virtual minions, a quantity of identity identifiers needing to be displayed increases and a player needs to memorize a relatively large quantity of identity identifiers, thereby increasing complexity for the player to distinguish the element attributes of the virtual minions. In this way, efficiency of human-computer interaction for summoning a virtual minion is improved.

FIG. 4 shows a flowchart of a method for summoning a virtual minion according to an exemplary embodiment of this application. The method may be performed by a computer device. Specifically, in the embodiment shown in FIG. 3, operation 520 may be implemented as operation 522 and operation 524, and operation 530 may be implemented as operation 532.

Operation 522: Display, in response to a touch and hold operation for the first element card, the position cursor at an initial position in the virtual environment.

For example, the selection operation for the first element card includes a touch and hold operation for the first element card. For example, when the first element card is kept pressed, the position cursor is displayed at an initial position in the virtual environment. In an example, the initial position is a central position of the displayed virtual environment.

In an exemplary implementation, operation 522 in this embodiment may be implemented as:

displaying the position cursor at the initial position in the virtual environment in response to the touch and hold operation for the first element card, and switching and displaying the first element card on a peripheral side of the initial position.

For example, in response to the touch and hold operation for the first element card, the first element card is switched and displayed on a peripheral side of the initial position, so that selection of the first element card can be visually prompted. In addition, the position of the first element card is switched to be displayed, so that the first element card can be prevented from being blocked when a user touches and holds the first element card. The first element card is switched and displayed on the peripheral side of the initial position, so that visual saliency of the position cursor at the initial position can be further increased, significantly indicating the initial position in the virtual environment. In addition, through the element attribute identifier on the first element card, the element attribute of the virtual minion summoned through the first element card is indicated.

Operation 524: Display, in response to a drag operation, that the position cursor moves from the initial position to the first position in conjunction with the touch and hold operation. In other words, the two operations happen simultaneously.

For example, in conjunction with the touch and hold operation, a user, without the need to search for a new control, can select the first element card and thus adjust the position cursor through only one human-computer interaction operation for the first element card. In an example, a direction of the drag operation is the same as a direction in which the initial position points to the first position. For example, the drag operation is sliding rightward to implement dragging of the first element card. Correspondingly, the direction in which the initial position points to the first position in the virtual environment is a rightward direction.

In an exemplary implementation, operation 524 in this embodiment may be implemented as:

displaying that the position cursor moves from the initial position to the first position, and displaying that the first element card moves from the peripheral side of the initial position to a peripheral side of the first position following the position cursor, in response to a drag operation in conjunction with the touch and hold operation.

For example, the first element card moves following the position cursor by adjusting to the peripheral side of the first position the position cursor, thereby ensuring that the first element card is always displayed on the peripheral side of the position cursor and ensuring visual saliency of the position cursor. The first element card is displayed on the peripheral side during a position adjustment process for the position cursor, so that an element attribute of a virtual minion summoned through the first element card can be continuously indicated.

In an example, transparency of the first element card displayed on the peripheral side of the position cursor is increased relative to transparency of the first element card displayed in operation 510. To be specific, in response to the selection operation for the first element card, a position of the first element card is switched and displayed on the peripheral side of the position cursor and is displayed through a higher transparency degree. For example, before the selection operation, the first element card is displayed as being opaque, and after the selection operation, the first element card is displayed as being semitransparent.

Operation 532: Summon, in response to a release operation for the first element card, the virtual minion at the first position in the virtual environment.

For example, in response to the release operation for the first element card, a user completes adjustment of the position cursor and summons the virtual minion at the first position displayed through the position cursor, and the virtual minion in the virtual environment is displayed. For example, the virtual minion is displayed at the first position displayed through the position cursor. For example, when the virtual minion is displayed, an entrance animation of the virtual minion may also be displayed, which is separately described below.

Based on the above, according to the method provided in this embodiment, an element attribute identifier is displayed on a virtual card, and an element attribute of a summoned virtual minion is indicated through the element attribute identifier, so as to provide a human-computer interaction manner in which a virtual minion to enter a field is summoned through a touch and hold operation and a release operation for the element card, and provide a function entry for adjusting a summoning position of the virtual minion in the virtual environment. The element attribute identifier is displayed on the virtual card, a problem in the related art is prevented in which, in the event of a plurality of types of virtual minions, the element attribute of the virtual minion cannot be directly presented by displaying an identity identifier of the virtual minion, and as an increase in the types of the virtual minions, a quantity of identity identifiers needing to be displayed increases and a player needs to memorize a relatively large quantity of identity identifiers, thereby increasing complexity for the player to distinguish the element attributes of the virtual minions. In this way, efficiency of human-computer interaction for summoning a virtual minion is improved.

Next, the entrance animation of the virtual minion is introduced. In each of the foregoing embodiments, the foregoing summoning a virtual minion at the first position in the virtual environment may be implemented as:

displaying the entrance animation of the virtual minion at the first position in the virtual environment.

For example, summoning a virtual minion includes an entrance stage of the virtual minion and an activity stage of the virtual minion. For example, in the entrance stage of the virtual minion, the entrance animation of the virtual minion is displayed, and in the activity stage of the virtual minion, the virtual minion performs a virtual activity in the virtual environment. In an example, in the entrance stage of the virtual minion, the virtual minion does not have an ability to perform the virtual activity, which is also referred to as a wind-up stage before entering a field, and after the virtual minion enters a field, the virtual minion performs the virtual activity. For example, the virtual minion has an autonomous behavior capability, and performs the virtual activity in the virtual environment.

For example, the entrance animation is at least one of an animation, a picture, or a text displayed on a peripheral side of the virtual character. The entrance animation includes materials, such as a map, a skeletal model, and a special effect. An element attribute identifier in a first element card also has materials, such as a map. The entrance animation and the element attribute identifier of the first element card have at least one identical material style. The same material style described above does not limit that the element attribute identifier and the entrance animation use the same material resource, and is only used for indicating that the element attribute identifier and the entrance animation include at least one of the same shape, the same texture, or the same material.

FIG. 5 shows a schematic diagram of an entrance animation of a virtual minion according to an exemplary embodiment of this application. An element attribute of a first virtual minion 410 is a virtual electricity element attribute. For example, the first virtual minion 410 has an ability to initiate a virtual attack accompanied by a virtual electric shock effect and/or has an ability to avoid virtual damage caused by virtual lightning strike in the virtual environment. The entrance animation of the first virtual minion 410 includes a thunderbolt effect 415 on a peripheral side of the first virtual minion 410. A shape of a first thunderbolt symbol 415a in the thunderbolt effect 415 is the same as a shape of the element attribute identifier of the first element card. A filling texture of a second thunderbolt light effect 415b in the thunderbolt effect 415 is the same as a filling texture of the element attribute identifier of the first element card, both of the filling textures having a highlighted crack texture of thunderbolt in the real world.

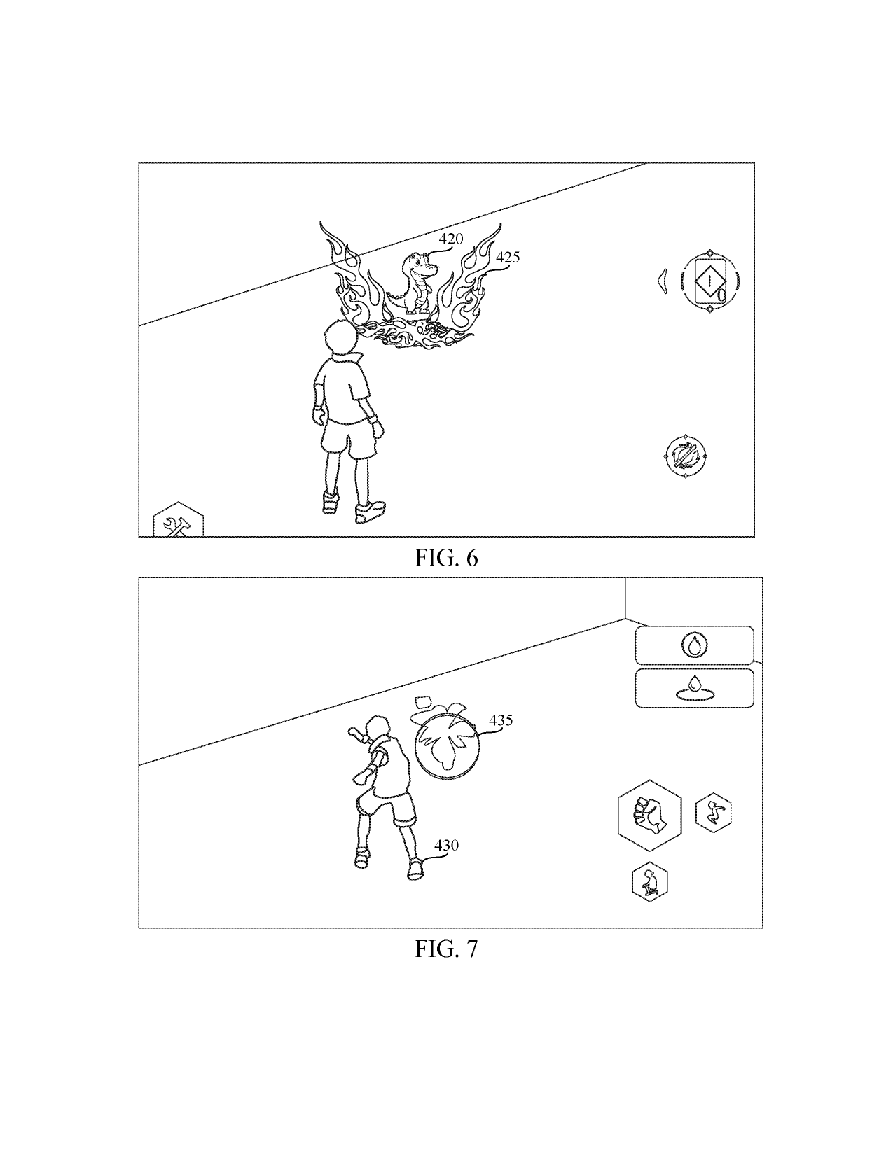

FIG. 6 shows a schematic diagram of an entrance animation of a virtual minion according to an exemplary embodiment of this application. An element attribute of a second virtual minion 420 is a virtual fire element attribute. For example, the second virtual minion 420 has an ability to initiate a virtual attack accompanied by a virtual flame effect and/or has an ability to avoid virtual damage caused by a virtual flame in the virtual environment. The entrance animation of the second virtual minion 420 includes a flame effect 425 on a peripheral side of the second virtual minion 420. A shape of a flame in the flame effect 425 is the same as a shape of the element attribute identifier of the first element card, both shapes having an outer edge shape of a flame in the real world.

Display that a virtual minion performs a virtual activity in the virtual environment.

For example, after the virtual minion enters a field in the virtual environment, the virtual minion is displayed in the virtual environment, and that the virtual minion performs a virtual activity in the virtual environment is displayed. For example, the virtual minion, as a teammate of a primarily controlled virtual character controlled by a user, performs the virtual activity together with the primarily controlled virtual character. For example, the user commands the virtual minion to perform the virtual activity in the virtual environment, thereby commanding the virtual minion to complete a task in cooperation with the primarily controlled virtual character. For example, the virtual minion has an autonomous behavior capability. The user may command the virtual minion, or the virtual minion may perform the virtual activity based on the autonomous behavior capability of the virtual minion. For example, the virtual activity performed by the virtual minion in the virtual environment includes, but is not limited to, at least one of constructing a virtual article in the virtual environment, building a virtual building, collecting a virtual article, exploring the virtual environment, farming a virtual land, or participating in a virtual battle. In an exemplary example, the virtual minion is only configured to perform a virtual activity simulating labor work in the real world in the virtual environment, such as constructing a virtual article, building a virtual building, or collecting a virtual article. In an exemplary example, the virtual environment provides a space for the primarily controlled virtual character and the virtual minion to perform the virtual activity, and the virtual environment provides the virtual space for free exploration. The virtual environment is also referred to as an open-world virtual environment, a large-map virtual environment, and the like.

In some embodiments, before displaying the entrance animation of the virtual minion, the method further includes:

displaying an animation in which the primarily controlled virtual character throws out the first element card toward the first position.

Before displaying the entrance animation of the virtual minion, in response to the trigger operation for the first element card, an animation in which the primarily controlled virtual character throws out the first element card is displayed, a way the primarily controlled virtual character performs throwing is displayed, and a possessed first element card is used. In this way, immersion of a user in a virtual environment is improved, immersion is improved for human-computer interaction between an operation of a user and a primarily controlled virtual character in the virtual environment, and the user is provided with immersion that the primarily controlled virtual character uses the first element card. FIG. 7 shows a schematic diagram of a throwing animation according to an exemplary embodiment of this application. A body pose of a primarily controlled virtual character 430 is switched from an upright pose to an arm-swinging pose, and a throwing effect 435 at a first position where a position cursor is located is further included. The throwing effect 435 is a virtual airflow generated by throwing out a first virtual card.

Based on the above, according to the method provided in this embodiment, an element attribute identifier is displayed on a virtual card, and an element attribute of a summoned virtual minion is indicated through the element attribute identifier, so as to provide a human-computer interaction manner in which a virtual minion to enter a field is summoned through a selection operation and a trigger operation for an element card. In a process in which a virtual minion is summoned to enter a field, the throwing animation of the first element card and an entrance animation of the virtual minion are displayed, thereby improving immersion of a user in the virtual environment and providing the user with immersion that the primarily controlled virtual character uses the first element card. The element attribute identifier is displayed on the virtual card, a problem in the related art is prevented in which, in the event of a plurality of types of virtual minions, the element attribute of the virtual minion cannot be directly presented by displaying an identity identifier of the virtual minion, and as an increase in the types of the virtual minions, a quantity of identity identifiers needing to be displayed increases and a player needs to memorize a relatively large quantity of identity identifiers, thereby increasing complexity for the player to distinguish the element attributes of the virtual minions. In this way, efficiency of human-computer interaction for summoning a virtual minion is improved.

Next, the element attribute identifier of the first element card is described.

For example, an element attribute corresponding to the element attribute identifier includes at least one of the following:

Virtual electricity element attribute. For example, the virtual electricity element attribute is configured for indicating resistance to virtual electric power in a virtual environment or an ability to utilize the virtual electric power. For example, when the virtual minion has the virtual electricity element attribute, the virtual minion, through a carried or possessed virtual skill or virtual prop, can utilize the virtual electric power and initiate a virtual activity related to the virtual electric power in the virtual environment, for example, initiating a virtual attack accompanied by a virtual electric shock effect. For example, the virtual minion has resistance to the virtual electric power, for example, avoiding virtual damage caused by virtual lightning strike in the virtual environment.

Virtual fire element attribute. For example, the virtual fire element attribute is configured for indicating resistance to a virtual flame in a virtual environment or an ability to utilize the virtual flame. For example, when the virtual minion has the virtual fire element attribute, the virtual minion, through a carried or possessed virtual skill or virtual prop, can utilize the virtual flame and initiate a virtual activity related to the virtual flame in the virtual environment, for example, initiating a virtual attack accompanied by a virtual flame effect. For example, the virtual minion has resistance to the virtual flame, for example, avoiding virtual damage caused by the virtual flame in the virtual environment.

Virtual water element attribute. For example, the virtual water element attribute is configured for indicating resistance to a virtual water flow in the virtual environment or an ability to utilize the virtual water flow. For example, when the virtual minion has the virtual water element attribute, the virtual minion, through a carried or possessed virtual skill or virtual prop, can utilize the virtual water flow and initiate a virtual activity related to the virtual water flow in the virtual environment, for example, initiating a virtual attack accompanied by a virtual water flow effect. For example, the virtual minion has resistance to the virtual water flow, for example, avoiding virtual damage caused by the virtual water flow in the virtual environment.

Virtual soil element attribute. For example, the virtual soil element attribute is configured for indicating resistance to virtual soil in the virtual environment or an ability to utilize the virtual soil. For example, when the virtual minion has the virtual soil element attribute, the virtual minion, through a carried or possessed virtual skill or virtual prop, can utilize the virtual soil and initiate a virtual activity related to the virtual soil in the virtual environment, for example, initiating a virtual attack accompanied by a virtual soil aggregation effect. For example, the virtual minion has resistance to the virtual soil, for example, avoiding virtual damage caused by falling of the virtual soil in the virtual environment.

Virtual metal element attribute. For example, the virtual metal element attribute is configured for indicating resistance to a virtual metal in the virtual environment or an ability to utilize the virtual metal. For example, when the virtual minion has the virtual metal element attribute, the virtual minion, through a carried or possessed virtual skill or virtual prop, can utilize the virtual metal, and initiate a virtual activity related to the virtual metal in the virtual environment, for example, obtaining a virtual shield of a virtual metal material. For example, the virtual minion has resistance to the virtual metal, for example, avoiding virtual damage caused through an attack prop having the virtual metal material in the virtual environment.

Virtual illumination element attribute. For example, the virtual illumination element attribute is configured for indicating resistance to virtual illumination in the virtual environment or having an ability to utilize the virtual illumination. For example, when the virtual minion has a virtual illumination element attribute, the virtual minion, through a carried or possessed virtual skill or virtual prop, can utilize the virtual illumination and initiate a virtual activity related to the virtual illumination in the virtual environment, for example, aggregating virtual sunlight in the virtual environment and initiating a light-beam virtual attack through the virtual sunlight. For example, the virtual minion has resistance to the virtual illumination, for example, avoiding high-temperature damage caused by the virtual sunlight in the virtual environment.

Virtual dark element attribute. For example, the virtual dark element attribute is configured for indicating resistance to a virtual dark element in the virtual environment or an ability to utilize the virtual dark element. For example, when the virtual minion has a virtual dark element attribute, the virtual minion, through a carried or possessed virtual skill or virtual prop, can utilize the virtual dark element and initiate a virtual activity related to the virtual dark element in the virtual environment, for example, at a night time in the virtual environment, utilizing the virtual dark element to initiate a virtual attack having an additive effect. For example, the virtual minion has resistance to the virtual dark element, for example, avoiding low-temperature damage at night time in the virtual environment.

Based on the above, according to the method provided in this embodiment, the element attribute identifier is displayed on the virtual card, the element attribute identifier can indicate the element attribute of the summoned virtual minion, so as to provide a human-computer interaction manner in which the virtual minion is summoned to enter a field through the selection operation and the trigger operation for the element card. The element attribute of the virtual minion is interrelated with the environment element in the virtual environment, so that the virtual minion can utilize the virtual element, or have resistance to the virtual element, thereby improving richness of an attribute of the virtual minion in the virtual environment.

Next, the first element card is described as follows. For example, in response to a trigger operation for the first element card, a virtual minion is summoned at a first position in a virtual environment, and the virtual minion is a candidate pet character configured by a primarily controlled virtual character and required to enter a field. In an example, the primarily controlled virtual character captures or purchases a plurality of virtual minions in the virtual environment and configures, through a human-computer interaction operation, a virtual minion team to enter a field for the primarily controlled virtual character. The virtual minion team is also referred to as a virtual minion team to enter a battle. The virtual minion team includes one or more candidate virtual minions. The virtual minion summoned based on the first element card is a virtual minion in the virtual minion team, and the virtual minion summoned based on the first element card is also one of the candidate virtual minions.

When the primarily controlled virtual character is configured with at least two candidate virtual minions, at least two candidate virtual minions in virtual characters, that need to enter a field, configured for the primarily controlled virtual character have element attributes consistent with element attribute identifiers. For example, when the primarily controlled virtual character is configured with at least two candidate virtual minions, a summoned virtual minion cannot be uniquely determined through an element attribute identifier on a first element card. In an implementation, when the primarily controlled virtual character is configured with at least two candidate virtual minions, the first element card includes identity identifiers of the virtual minions. A manner in which more identity identifiers of virtual minions are displayed is used (for example, displaying at least one of a nickname, an avatar, or an identity identifier number of a virtual minion), more bases for selecting a virtual minion are displayed, and then the virtual minion is summoned.

In another implementation, when the primarily controlled virtual character is configured with at least two candidate virtual minions, a virtual minion displayed at a first position is determined from the at least two candidate virtual minions. For example, a virtual minion summoned in a virtual environment is randomly determined, or the at least two candidate virtual minions are arranged into a pet queue based on a preset order (for example, ascending/descending sorting is performed based on at least one of parameters, such as a virtual level of a candidate virtual minion or a time when it is obtained), and a candidate virtual minion located at a head of the pet queue is determined as a virtual minion summoned in a virtual environment. Because virtual attributes of the at least two candidate virtual minions are consistent with the element attribute identifiers, a user's demand to summon a virtual minion having virtual attributes corresponding to the element attribute identifier may be satisfied.

Further, in response to the selection operation for the first element card, the pet queue is further displayed. For a way at least two candidate pets in the pet queue are sorted, reference may be made to the foregoing description. The pet queue is configured to display identity identifiers of the at least two candidate virtual minions. For example, the selection operation for the first element card is implemented as a touch and hold operation, and a human-computer interaction operation for switching a candidate virtual minion in a pet queue that is in a selected state is a newly added obtaining click operation when the touch and hold operation is maintained. For example, in response to the newly added obtaining click operation when the touch and hold operation is maintained, a first candidate virtual minion at a first position in the pet queue is switched from a selected state to an unselected state, and a second candidate virtual minion at a second position is switched from an unselected state to a selected state. The first position in the pet queue is an adjacent position before the second position. In response to a release operation for the first element card, the candidate virtual minion in the selected state in the pet queue is determined as the virtual minion, and the virtual minion is summoned at the first position in the virtual environment. In some embodiments, in response to the selection operation for the first element card, the at least one element card is switched and displayed as a pet queue corresponding to the first element card.

In an exemplary design of this application, when a plurality of element cards are provided in operation 510, a display order of the plurality of element cards may be preset. In an example, the display order of the plurality of element cards is determined based on a human-computer interaction operation of a user. For example, the plurality of element cards are displayed in an order of a virtual electricity element attribute, a virtual fire element attribute, and a virtual water element attribute. In another example, the display order of the plurality of element cards is provided in advance by an application program providing a virtual environment, and does not need to be preset by a user through a human-computer interaction operation.

For example, the display order of the plurality of element cards may be determined based on a position where a primarily controlled virtual character is located. For example, a plurality of element cards possessed by a primarily controlled virtual character and position information of the primarily controlled virtual character in the virtual environment are obtained. A card sorting model is called to predict the plurality of element cards and the position information, to obtain display order information of the plurality of element cards. The plurality of element cards are sorted based on the display order information.

For example, the position information in the virtual environment includes a position coordinate where the primarily controlled virtual character is located. In some embodiments, the position information further includes at least one of climate information at the position coordinate, a mineral type at the position coordinate, a neutral/hostile camp virtual character adjacent to the position coordinate, or a type of a virtual land block where the position coordinate is located.

The climate information in the virtual environment has an additive effect and/or an impairment effect on an element attribute of a virtual minion. For example, when a virtual climate in a virtual environment is a desert climate, the desert climate has a high-temperature characteristic, has a positive additive effect on a virtual fire element attribute, and has a negative impairment effect on a virtual water element attribute. When the virtual climate in the virtual environment is a rainforest climate, the rainforest climate has a characteristic of high-frequency rainfalls, has a positive additive effect on a virtual water element attribute, and has a negative impairment effect on a virtual fire element attribute. The mineral type at the position coordinate is configured for indicating a virtual mineral resource that can be obtained by digging a virtual land block in the virtual environment. The mineral type is inputted into the card sorting model to provide a basis for the card sorting model to predict an intention of a player to summon a virtual minion to perform a mining activity. Based on efficiency for performing the mining activity, a basis is provided for predicting an intention of a player to summon virtual minions having different element attributes. The neutral/hostile camp virtual character adjacent to the position coordinate is configured for indicating a danger degree in the vicinity of the position coordinate. The neutral/hostile camp virtual character is inputted into the card sorting model to provide a basis for the card sorting model to predict an intention of a player to summon a virtual minion to perform a virtual battle. Based on efficiency for performing the virtual battle, a basis is provided for predicting an intention of a player to summon virtual minions having different element attributes. The type of the virtual land block where the position coordinate is located is configured for indicating that the type of the virtual land block is at least one of a farmland type, a pasture type, an industrial area type, an entertainment area type, or a residential area type. The type of the virtual land block is inputted into the card sorting model to provide a basis for the card sorting model to predict a type of a virtual activity that needs to be performed by the virtual minion after a player summons the virtual minion.

For example, the card sorting model has an ability to predict an intention of a player to summon a virtual minion at a position where a primarily controlled virtual character is located. The display order information refers to predicted intentions in a descending order sorting of a user to summon virtual minions having different element attributes. A plurality of element cards are sorted based on the display order information, so that an element attribute of a virtual minion that a user has a stronger intention to summon is displayed at the front. Further, a process of training the card sorting model is described as follows. Sample position information, sample card information, and sample summoning information are obtained. The sample summoning information is configured for indicating an element attribute of a virtual minion summoned at a sample position. The sample position information is configured for indicating climate information of the sample position. The sample card information is configured for indicating information of an element card possessed by a primarily controlled virtual character when a virtual minion is summoned. For example, the sample position information and the sample summoning information are summoning operations, which are obtained through statistics, of real users for virtual minions in the past. The foregoing information is obtained through statistics under user authorization and consent. In an example, separate consent is obtained from a user each time the information is obtained.

For example, the card sorting model is called to perform prediction on the sample position information and the sample card information, to obtain predicted summoning information. Based on a difference between the predicted summoning information and the sample summoning information, back error propagation training is performed on the card sorting model to obtain a trained card sorting model. In some embodiments, at least one of sample climate information, a sample mineral type, a sample virtual character, or a sample virtual land block type is further obtained. For description of the foregoing information, reference may be made to the foregoing description, and details are not repeated herein again. Correspondingly, the predicted summoning information is obtained through prediction on the sample position information, the sample card information, and at least one of the sample climate information, the sample mineral type, the sample virtual character, or the sample virtual land block type by calling the card sorting model.

The following describes the first position at which the virtual minion is summoned. The first position includes at least one of the following:

First position is located at a central point of an observation picture of the virtual environment.

For example, the observation picture of the virtual environment is based on an observation result of a virtual environment by a virtual camera of a primarily controlled virtual character; and through adjustments of a position and a perspective of the primarily controlled virtual character, a position of the first position in the virtual environment is adjusted.

First position located in a moving direction or a facing direction of the primarily controlled virtual character.

For example, when a virtual minion has a virtual defense attribute for resisting a virtual attack, a virtual character is summoned to protect a primarily controlled virtual character in a virtual environment. A pet character is summoned at the first position in the moving direction or the facing direction of the primarily controlled virtual character, so that the pet character may be summoned in a direction in which the primarily controlled virtual character is intended to move, and then, based on a virtual defense attribute of the virtual minion, the primarily controlled virtual character is prevented from receiving a virtual attack.

First position located in a direction in which the primarily controlled virtual character points to a hostile virtual character.

For example, when a virtual minion has a virtual attack attribute for initiating a virtual attack, the direction in which the primarily controlled virtual character points to the hostile virtual character is a direction closest to the hostile virtual character. A virtual minion is summoned in the direction in which the primarily controlled virtual character points to the hostile virtual character, so that the virtual attack attribute of the virtual minion can be fully used, and a virtual attack is initiated on the hostile virtual character in time.

First position located in a direction in which the primarily controlled virtual character points to a point of interest marked in a virtual map.

For example, when a virtual minion has a virtual mount attribute for carrying the primarily controlled virtual character to move, the direction in which the primarily controlled virtual character points to the point of interest marked in the virtual map is a direction closest to the point of interest. The virtual minion is summoned in the direction in which the primarily controlled virtual character points to the point of interest marked in the virtual map, so that the virtual mount attribute of the virtual minion may be fully used, and the primarily controlled virtual character is controlled in time to ride the virtual minion to move toward the point of interest.

First position is located on a first virtual terrain.

For example, the first virtual terrain has a gain effect on a first attribute of a virtual minion. A summoning position of a virtual minion is determined as the first position, thereby providing a favorable condition for the virtual minion to perform a virtual activity in the virtual environment.

In an implementation of this application, this embodiment is combined with the embodiment corresponding to FIG. 3 above. In response to a selection operation for a first element card, a position cursor is automatically displayed to the first position described above. In another implementation, in response to a selection operation for a first element card, a position cursor is displayed at an initial position (for details, reference may be made to the description in the embodiment corresponding to FIG. 4, and details are not repeated herein again), and a position switching control is displayed. In response to a drag operation, when dragging is performed to the position switching control, the position cursor is displayed to move from the initial position to the first position, where the first position is at least one of those described above.

Based on the above, according to the method provided in this embodiment, an element attribute identifier is displayed on a virtual card, and the element attribute identifier can indicate an element attribute of a summoned virtual minion, so as to provide a human-computer interaction manner in which a virtual minion to enter a field is summoned through a selection operation and a trigger operation for an element card. The first position is a summoning position of a virtual minion in a virtual environment and different types of virtual minions correspond to different first positions, thereby improving human-computer interaction efficiency for a user to select a summoning position of a virtual minion.

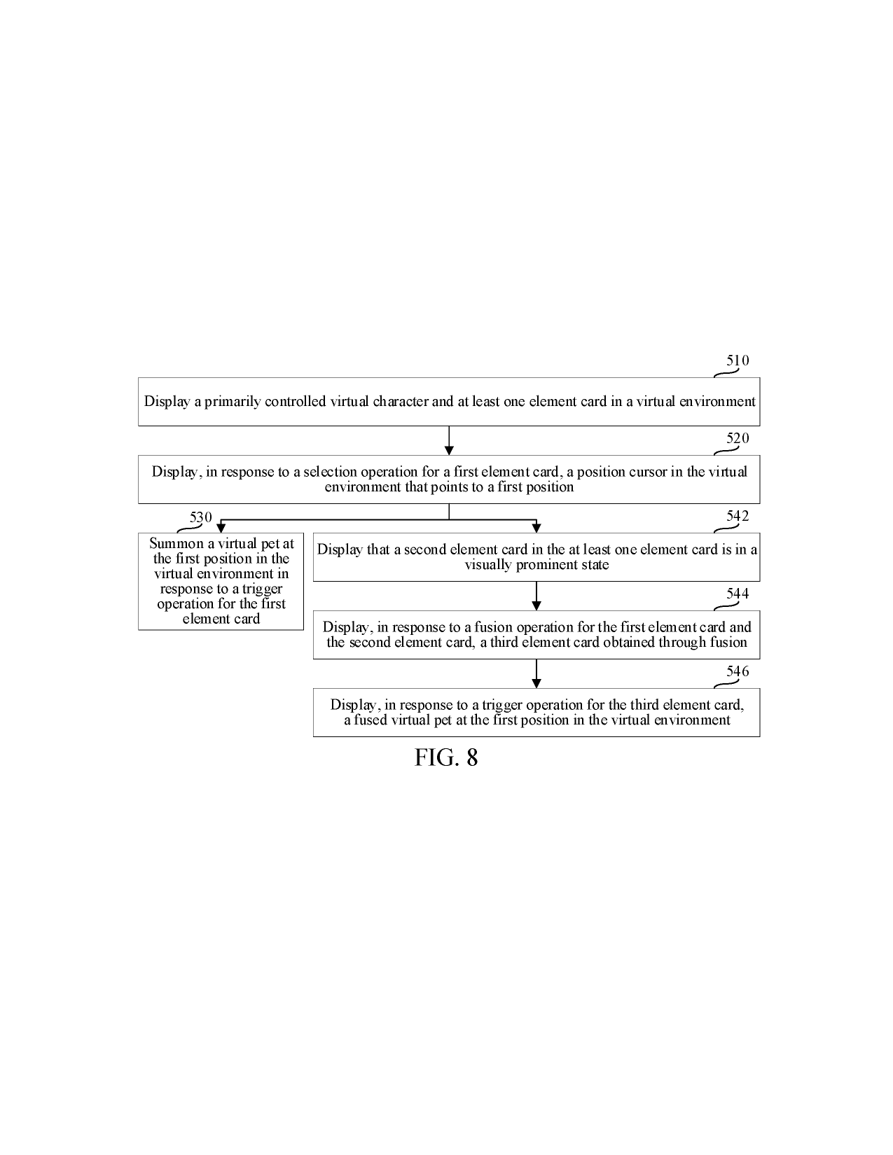

FIG. 8 shows a flowchart of a method for summoning a virtual minion according to an exemplary embodiment of this application. The method may be performed by a computer device. To be specific, according to the embodiment shown in FIG. 3, operation 542, operation 544, and operation 546 are further included.

Operation 542: Change a second element card in the at least one element card to be in a visually prominent state and display the second element card accordingly.

For example, the second element card displayed in the visually prominent state satisfies a fusion condition. For example, the second element card displayed in the visually prominent state has an ability to fuse with the first element card. A user is prompted, in a visually prominent mode, that the second element card exists, prompting the user to perform a fusion operation on the first element card and the second element card.

In an exemplary implementation, the second element card satisfies a fusion condition includes at least one of the following:

No attribute restraint relationship exists between a first attribute corresponding to the first element card and a second attribute corresponding to the second element card. In an example, an attribute restraint relationship between a virtual fire element attribute and a virtual water element attribute exists, and an attribute restraint relationship between a virtual illumination element attribute and a virtual dark element attribute exists. For the description of the virtual element attributes, reference may be made to the foregoing description of the specification, and details are not repeated herein again.

A virtual volume difference between a virtual minion corresponding to the first element card and a virtual minion corresponding to the second element card does not exceed a volume difference threshold. For example, when the virtual volume difference between the virtual minion corresponding to the first element card and the virtual minion corresponding to the second element card is excessively large (exceeding the volume difference threshold), an association degree between the virtual minions is low, and a condition for fusing the two virtual cards to obtain a third virtual card does not exist.

A first virtual terrain where the primarily controlled virtual character is located has no impairment effect on the virtual minion corresponding to the second element card. When the first virtual terrain has no impairment effect (also referred to as a negative effect) on the virtual minion corresponding to the second element card, the first virtual terrain does not produce an adverse effect on the virtual minion corresponding to the second element card.

Operation 544: In response to a fusion operation, fuse the first element card and the second element card into a third element card obtained through fusion.

For example, the third element card is obtained through fusion based on the first element card and the second element card. In an example, an element attribute identifier included in the third element card is the same as the element attribute identifier on the first element card or the second element card. The third element card is a card obtained after enhancing the first element card or the second element card. In another example, the element attribute identifier included in the third element card is different from both the element attribute identifier on the first element card and the element attribute identifier on the second element card. Further, the element attribute identifier on the third element card can only be obtained through fusion of cards and is not an element attribute identifier of an element attribute of a virtual minion which is directly captured or purchased by a primarily controlled virtual character.

In an exemplary implementation, operation 544 may be implemented as: displaying, in response to a moving operation for the first element card, the third element card obtained through fusion when a distance between the first element card and the second element card does not exceed a distance threshold. For example, a fusion operation includes moving the first element card to an adjacent position where a distance from the second element card does not exceed the distance threshold. Further, the fusion operation further includes: the distance between the first element card and the second element card does not exceed the distance threshold, and a duration for which the distance between the first element card and the second element card does not exceed the distance threshold exceeds a time threshold. For example, the first element card is moved to the adjacent position where the distance from the second element card does not exceed the distance threshold, which is configured for indicating that a user has an intention to fuse the first element card and the second element card; and the duration for which the distance between the first element card and the second element card does not exceed the distance threshold exceeds the time threshold, which may prevent misoperation and avoid accidentally triggering the fusion of the third element card caused by the first element card that moves following a position cursor being adjacent to the second element card when the position cursor is adjusted.

Operation 546: Generate and display, in response to a trigger operation for the first element card, a fused virtual minion at the first position in the virtual environment.

For example, the fused virtual minion is displayed at the first position. In other words, the fused virtual minion is summoned at the first position in the virtual environment. For example, the fused pet character is like the virtual minion described above. An entrance animation of the fused virtual minion is displayed at the first position in the virtual environment. The entrance animation and the element attribute identifier in the third element card have at least one identical material style. That the fused virtual minion performs a virtual activity in the virtual environment is displayed.

Based on the above, according to the method provided in this embodiment, an element attribute identifier is displayed on a virtual card, and an element attribute of a summoned virtual minion can be indicated through the element attribute identifier, so as to provide a human-computer interaction manner in which a virtual minion to enter a field is summoned through a selection operation and a trigger operation for an element card. The element attribute identifier is displayed on the virtual card, a problem in the related art is prevented in which, in the event of a plurality of types of virtual minions, the element attribute of the virtual minion cannot be directly presented by displaying an identity identifier of the virtual minion, and as an increase in the types of the virtual minions, a quantity of identity identifiers needing to be displayed increases and a player needs to memorize a relatively large quantity of identity identifiers, thereby increasing complexity for the player to distinguish the element attributes of the virtual minions. In this way, efficiency of human-computer interaction for summoning a virtual minion is improved. A function entry for performing card fusion on different element cards is provided. A new third element card is obtained through fusion, and a fused virtual minion corresponding to the third element card is summoned, thereby improving richness of virtual minions in a virtual environment.

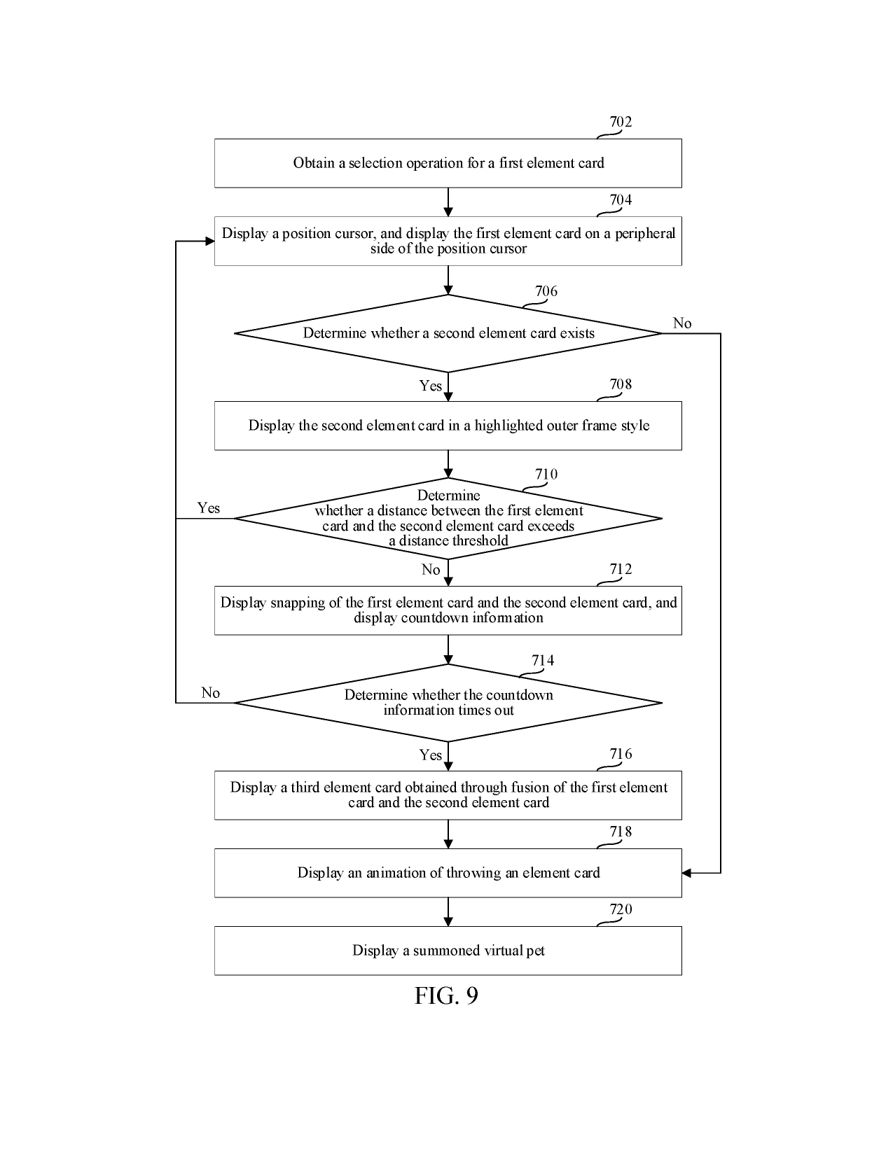

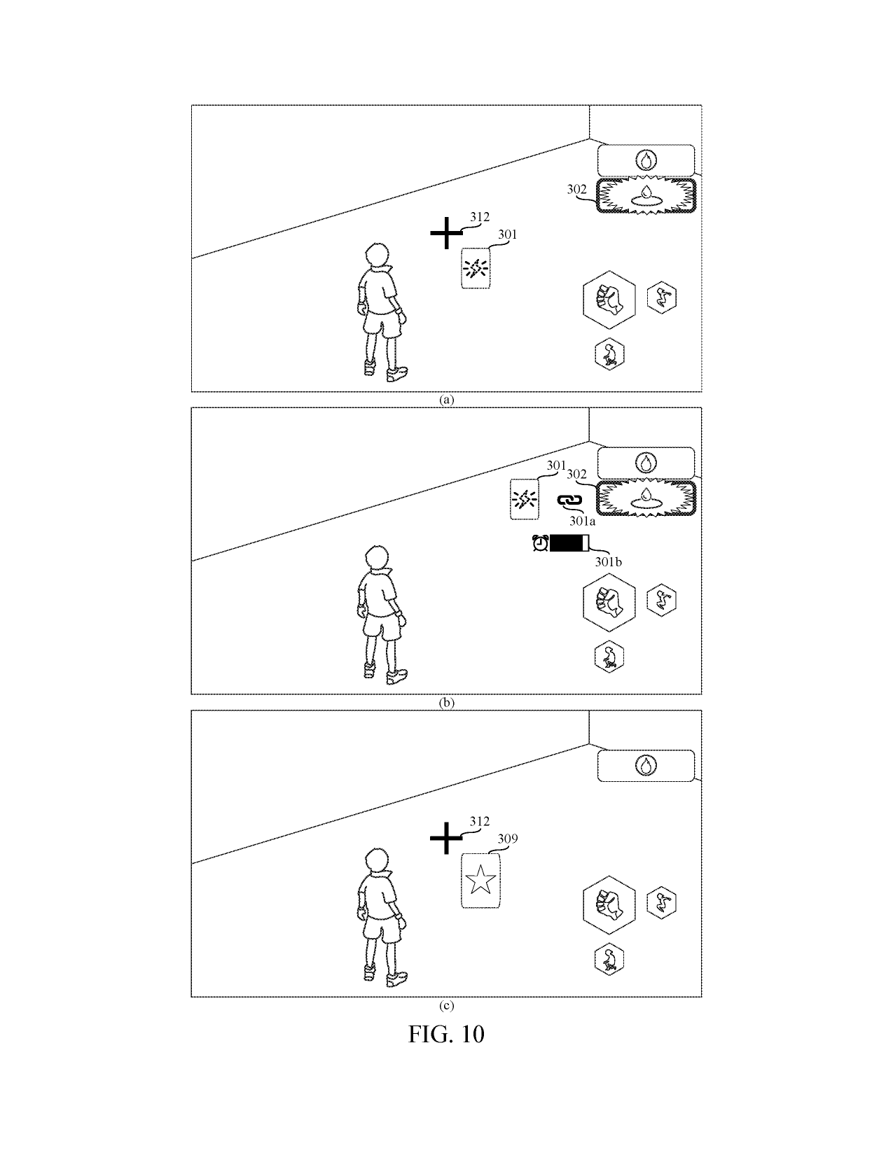

FIG. 9 shows a flowchart of a method for summoning a virtual minion according to an exemplary embodiment of this application. The method includes:

Operation 702: Obtain a selection operation for a first element card.

For example, in response to the selection operation for the first element card, an intention to use the first element card to summon a virtual minion occurs.

Operation 704: Display a position cursor and display the first element card on a peripheral side of the position cursor.

For example, the position cursor and position switching of the first element card are displayed in response to obtaining the selection operation in operation 702. For example, the position cursor is configured to indicate a position where a virtual minion is summoned in a virtual environment. For example, a position of the position cursor is adjusted by adjusting a position and a perspective direction of a primarily controlled virtual character. An exemplary position cursor is a central point position of an observation picture of a virtual environment by the primarily controlled virtual character.

Operation 706: Determine whether a second element card exists.

For example, when the second element card exists, operation 708 is performed; and when the second element card does not exist, operation 718 is performed.

For example, the second element card satisfies a fusion condition and has an ability to fuse with the first element card.

Operation 708: Display the second element card in a highlighted outer frame style.

For example, when the second element card exists, the second element card is displayed in the highlighted outer frame style. The highlighted outer frame style is used to present the second element card in a visually prominent manner. With reference to a subgraph (a) in FIG. 10, the position cursor 312 is located at a central point of the subgraph (a), and is configured to indicate a summoning position of a pet character in a virtual environment. The first element card 301 is displayed on a peripheral side of the position cursor 312. The second element card 302 is displayed in the highlighted outer frame style.

Operation 710: Determine whether a distance between the first element card and the second element card exceeds a distance threshold.

For example, when the distance between the first element card and the second element card exceeds the distance threshold, operation 704 is performed to continue displaying the position cursor and the first element card; and when the distance between the first element card and the second element card does not exceed the distance threshold, operation 712 is performed.

Operation 712: Display snapping of the first element card and the second element card, and display countdown information.

For example, when the distance between the first element card and the second element card does not exceed the distance threshold, it indicates that a user has an intention to fuse the first element card and the second element card. By displaying the countdown information, countdown time for fusing the first element card and the second element card is indicated.

With reference to a subgraph (b) in FIG. 10, when a distance between a first element card 301 and a second element card 302 does not exceed the distance threshold, a subgraph (a) is switched to display the subgraph (b). An association identifier 301a is displayed between the first element card 301 and the second element card 302 to present the snapping of the first element card and the second element card. Countdown information 301b is displayed to indicate countdown time for fusing the first element card and the second element card.

Operation 714: Determine whether the countdown information times out.

For example, when the countdown information times out, operation 716 is performed; and when the countdown information does not time out, operation 704 is performed to continue displaying the position cursor and the first element card.

Operation 716: Display a third element card obtained through fusion of the first element card and the second element card.

For example, when the countdown information times out, the third element card obtained through fusion of the first element card and the second element card is displayed. When the countdown information 301b in the subgraph (b) of FIG. 10 times out, the subgraph (b) is switched to display a subgraph (c), and a fused element card 309 obtained through fusion of the first element card 301 and the second element card 302 is displayed. The fused element card 309 is also referred to as a third element card. For example, an element attribute identifier on the fused element card 309 is different from both an element attribute identifier of the first element card 301 and an element attribute identifier of the second element card 302.

Operation 718: Display an animation of throwing the element card.

For example, the terminal displays an animation in which a primarily controlled virtual character throws out an element card to present triggering and use of the element card.

Operation 720: Display a summoned virtual minion.

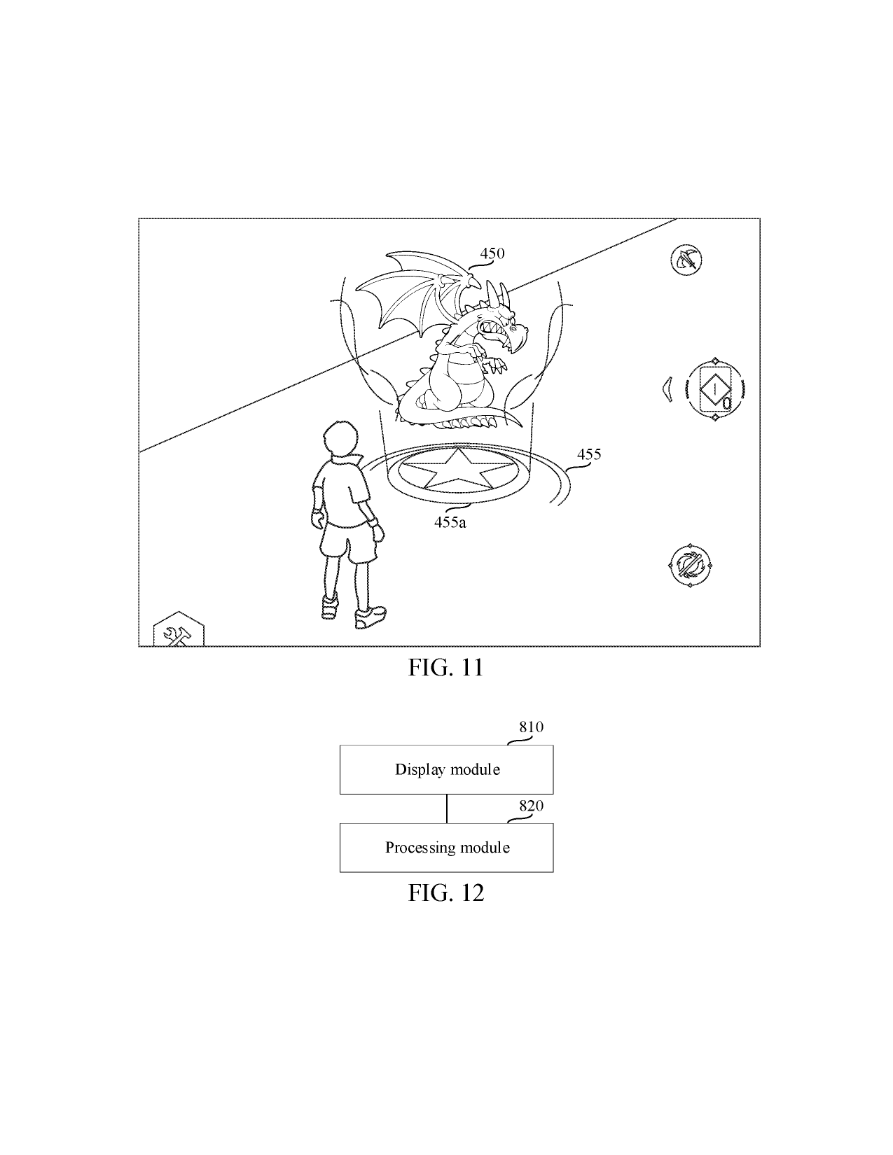

For example, an entrance animation of a virtual minion is displayed in a virtual environment, and the virtual minion performs a virtual activity in the virtual environment is displayed. FIG. 11 shows a schematic diagram of a fused virtual minion according to an exemplary embodiment of this application. A fused virtual minion 450 is displayed at a first position in a virtual environment in response to a trigger operation for a third element card. An element attribute of the fused virtual minion 450 is a virtual illumination element attribute. For example, the fused virtual minion 450 has an ability to aggregate virtual sunlight in the virtual environment and initiate a light-beam virtual attack through the virtual sunlight, and/or has an ability to prevent high-temperature damage caused by the virtual sunlight in the virtual environment. An entrance animation of the fused virtual minion 450 includes a light-and-shadow effect 455 on a peripheral side of the fused virtual minion 450. A shape of ground light and shadow 455a in the light-and-shadow effect 455 is the same as a shape of the element attribute identifier in the third element card shown in FIG. 10.

Based on the above, according to the method provided in this embodiment, an element attribute identifier is displayed on a virtual card, and an element attribute of a summoned virtual minion is indicated through the element attribute identifier, so as to provide a human-computer interaction manner in which a virtual minion to enter a field is summoned through a selection operation and a trigger operation for an element card. The element attribute identifier is displayed on the virtual card, a problem in the related art is prevented in which, in the event of a plurality of types of virtual minions, the element attribute of the virtual minion cannot be directly presented by displaying an identity identifier of the virtual minion, and as an increase in the types of the virtual minions, a quantity of identity identifiers needing to be displayed increases and a player needs to memorize a relatively large quantity of identity identifiers, thereby increasing complexity for the player to distinguish the element attributes of the virtual minions. In this way, efficiency of human-computer interaction for summoning a virtual minion is improved.

A person of ordinary skill in the art may understand that the foregoing embodiments may be independently implemented, or the foregoing embodiments may be combined in different manners to form new embodiments to implement the method for summoning a virtual minion according to this application.

FIG. 12 shows a structural block diagram of an apparatus for summoning a virtual minion according to an exemplary embodiment of this application. The apparatus includes a display module 810, configured to perform operation 510 in the embodiment of FIG. 3, where a first element card in the at least one element card includes an element attribute identifier; and a processing module 820, configured to perform operation 520 in the embodiment of FIG. 3, where a first position is a summoning position of the virtual minion in a virtual environment. The processing module 820 is further configured to perform operation 530 in the embodiment of FIG. 3, where an element attribute of the virtual minion is consistent with the element attribute identifier.

In an exemplary implementation of this embodiment, the processing module 820 is further configured to perform operation 522, operation 524, and operation 532 in the embodiment of FIG. 4. In an exemplary implementation of this embodiment, the processing module 820 is further configured to display the position cursor at the initial position in the virtual environment in response to the touch and hold operation for the first element card, and switching and displaying the first element card on a peripheral side of the initial position.

The processing module 820 is further configured to display that the position cursor moves from the initial position to the first position, and display that the first element card moves from the peripheral side of the initial position to a peripheral side of the first position following the position cursor, in response to a drag operation in conjunction with the touch and hold operation.

In an exemplary implementation of this embodiment, the processing module 820 is further configured to display an entrance animation of the virtual minion at the first position in the virtual environment, the entrance animation and the element attribute identifier of the first element card having at least one identical material style; and display that the virtual minion performs a virtual activity in the virtual environment.

In an exemplary implementation of this embodiment, the element attribute corresponding to the element attribute identifier includes at least one of a virtual electricity element attribute, a virtual fire element attribute, a virtual water element attribute, a virtual soil element attribute, a virtual metal element attribute, a virtual illumination element attribute, or a virtual dark element attribute.

In an exemplary implementation of this embodiment, the display module 810 is further configured to display an animation in which the primarily controlled virtual character throws out the first element card toward the first position. In an exemplary implementation of this embodiment, when the primarily controlled virtual character is configured with at least two candidate virtual minions, the first element card includes an identity identifier of the virtual minion, or the virtual minion displayed at the first position is determined from the at least two candidate virtual minions, where element attributes of the at least two candidate virtual minions are both consistent with the element attribute identifier.

In an exemplary implementation of this embodiment, the first position in the virtual environment includes at least one of the following:

the first position being located at a central point of an observation picture of the virtual environment; the first position being located in a moving direction or a facing direction of the primarily controlled virtual character, where the virtual minion has a virtual defense attribute for resisting a virtual attack; the first position being located in a direction in which the primarily controlled virtual character points to a hostile virtual character, where the virtual minion has a virtual attack attribute for initiating a virtual attack; the first position being located in a direction in which the primarily controlled virtual character points to a point of interest marked in a virtual map, where the virtual minion has a virtual mount attribute for carrying the primarily controlled virtual character to move; or the first position being located on a first virtual terrain, where the first virtual terrain has a gain effect on the first attribute of the virtual minion.

In an exemplary implementation of this embodiment, the display module 810 is further configured to perform operation 542 in the embodiment of FIG. 8. The second element card satisfies a fusion condition. The processing module 820 is further configured to perform operation 544 and operation 546 in the embodiment of FIG. 8.

In an exemplary implementation of this embodiment, the processing module 820 is further configured to display, in response to a moving operation for the first element card, the third element card obtained through fusion when a distance between the first element card and the second element card does not exceed a distance threshold.

In an exemplary implementation of this embodiment, the second element card satisfying a fusion condition includes at least one of: no attribute restraint relationship exists between a first attribute corresponding to the first element card and a second attribute corresponding to the second element card; a virtual volume difference between a virtual minion corresponding to the first element card and a virtual minion corresponding to the second element card does not exceed a volume difference threshold; or a first virtual terrain where the primarily controlled virtual character is located has no impairment effect on the virtual minion corresponding to the second element card.

When the apparatus provided in the foregoing embodiments implements functions of the apparatus, division of the foregoing various functional modules is merely used as an example for description. In an actual application, the function distribution may be finished by different functional modules according to actual requirements. To be specific, a content structure of a device is divided into different functional modules, to complete all or some of the functions described above.

Specific manners of performing operations by the modules of the apparatus in the foregoing embodiment have been described in detail in the embodiments related to the method. Technical effects obtained by performing the operations by the modules are the same as the technical effects in the embodiments related to the method, and details are not described herein again.

An embodiment of this application further provides a computer device. The computer device includes a processor and a memory. The memory has a computer program stored therein. The processor is configured to execute the computer program in the memory to implement the method for summoning a virtual minion provided in the foregoing method embodiments.

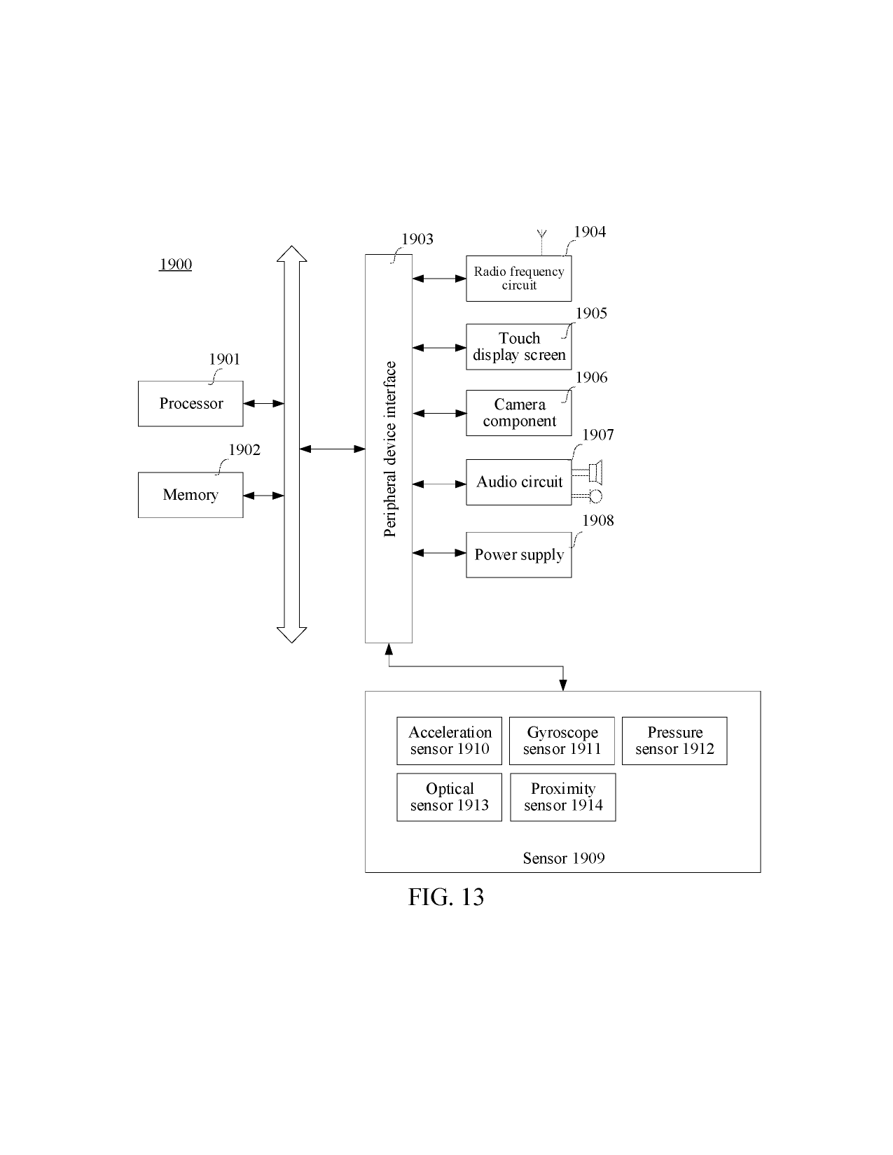

FIG. 13 shows a structural block diagram of a terminal according to an exemplary embodiment of this application. The terminal 1900 may be a smartphone, a tablet computer, a moving picture experts group audio layer III (MP3) player, a moving picture experts group audio layer IV (MP4) player, a notebook computer, or a desktop computer. The terminal 1900 may also be referred to as another name such as a user device, a portable terminal, a laptop terminal, or a desktop terminal.

Typically, the terminal 1900 includes a processor 1901 and a memory 1902. The processor 1901 may include one or more processing cores, for example, a 4-core processor or an 8-core processor. The processor 1901 may be implemented by using at least one of the following hardware forms: a digital signal processor (DSP), a field-programmable gate array (FPGA), and a programmable logic array (PLA). The processor 1901 may alternatively include a main processor and a coprocessor. The main processor is a processor configured to process data in an awake state, and is also referred to as a central processing unit (CPU). The coprocessor is a low power processor configured to process data in a standby state. In some embodiments, the processor 1901 may be integrated with a graphics processing unit (GPU). The GPU is configured to render and draw content that needs to be displayed on a display screen. In some embodiments, the processor 1901 may further include an artificial intelligence (AI) processor. The AI processor is configured to perform computing operations related to machine learning.

The memory 1902 may include one or more computer-readable storage media. The computer-readable storage media may be non-transient. The memory 1902 may further include a high-speed random access memory and a nonvolatile memory, for example, one or more disk storage devices or flash storage devices. In some embodiments, a non-transitory computer-readable storage medium in the memory 1902 is configured to store at least one instruction. The at least one instruction is configured for being executed by the processor 1901 to implement the method for summoning a virtual minion provided in the method embodiments of this application.

In some embodiments, the terminal 1900 may further include a peripheral device interface 1903 and at least one peripheral device. The processor 1901, the memory 1902, and the peripheral device interface 1903 may be connected through a bus or a signal line. Each peripheral device may be connected to the peripheral device interface 1903 through a bus, a signal line, or a circuit board. Specifically, the peripheral device includes at least one of a radio frequency (RF) circuit 1904, a touch display screen 1905, a camera component 1906, an audio circuit 1907, and a power supply 1908.

The peripheral device interface 1903 may be configured to connect at least one peripheral device related to input /output (I/O) to the processor 1901 and the memory 1902. In some embodiments, the processor 1901, the memory 1902, and the peripheral device interface 1903 are integrated on the same chip or the same circuit board. In some other embodiments, any one or two of the processor 1901, the memory 1902, and the peripheral device interface 1903 may be implemented on a separate chip or a separate circuit board, which is not limited in this embodiment. The RF circuit 1904 is configured to receive and transmit an RF signal, which is also referred to as an electromagnetic signal. The RF circuit 1904 communicates with a communication network and another communication device through the electromagnetic signal. The RF circuit 1904 converts an electrical signal into an electromagnetic signal for transmission, or converts a received electromagnetic signal into an electrical signal. In some embodiments, the RF circuit 1904 includes an antenna system, an RF transceiver, one or more amplifiers, a tuner, an oscillator, a DSP, a codec chipset, a subscriber identity module card, and the like. The RF circuit 1904 may communicate with another terminal through at least one wireless communication protocol. The wireless communication protocol includes, but is not limited to, the World Wide Web, a metropolitan area network, the Intranet, various generations of mobile communication networks (2G, 3G, 4G, and 5G), a wireless local area network, and/or a wireless fidelity (Wi-Fi) network. In some embodiments, the RF 1904 may further include a circuit related to near field communication (NFC), which is not limited in this application. The touch display screen 1905 is configured to display a user interface (UI). The UI may include graphics, a text, an icon, a video, and any combination thereof. The touch display screen 1905 further has a capability of capturing a touch signal on or above a surface of the touch display screen 1905. The touch signal may be inputted into the processor 1901 as a control signal for processing. In this case, the touch display screen 1905 may be further configured to provide a virtual button and/or a virtual keyboard, which are/is also referred to as a soft button and/or a soft keyboard. In some embodiments, one touch display screen 1905 may be provided, which is arranged on a front panel of the terminal 1900. In some other embodiments, at least two touch display screens 1905 may be provided, which are respectively arranged on different surfaces

of the terminal 1900 or in a folded design. In some still other embodiments, the touch display screen 1905 may be a flexible display screen, which is arranged on a curved surface or a folded surface of the terminal 1900. The touch display screen 1905 may further be arranged as a non-rectangular irregular pattern, i.e., a special-shaped screen. The touch display screen 1905 may be manufactured by using a liquid crystal display (LCD), an organic light-emitting diode (OLED), or the like. The camera component 1906 is configured to capture an image or a video. In some embodiments, the camera component 1906 includes a front camera and a rear camera. The front camera is arranged on the front panel of the terminal, and the rear camera is arranged on the back of the terminal. In some embodiments, at least two rear cameras are arranged, which are respectively any one of a main camera, a depth-of-field camera, a wide-angle camera, and a telephoto camera, to achieve background blur through fusion of the main camera and the depth-of-field camera, panoramic photographing and VR photographing through fusion of the main camera and the wide-angle camera, or another fusion photographing function. In some embodiments, the camera component 1906 may further include a flash. The flash may be a single-color-temperature flash, or may be a dual-color-temperature flash. The dual-color-temperature flash is a combination of a warm flash and a cold flash, which may be configured for light compensation at different color temperatures. The audio circuit 1907 may include a microphone and a speaker. The microphone is configured to collect sound waves of a user and an environment, convert the sound waves into an electrical signal and input the electrical signal to the processor 1901 for processing, or input the electrical signal to the RF circuit 1904 for implementing voice communication. To stereo acquisition or noise reduction, a plurality of microphones may be respectively arranged at different parts of the terminal 1900. The microphone may be further an array microphone or an omni-directional acquisition microphone. The speaker is configured to convert the electrical signals from the processor 1901 or the RF circuit 1904 into sound waves. The speaker may be a conventional film speaker, or may be a piezoelectric ceramic speaker. When the speaker is the piezoelectric ceramic speaker, the speaker not only may convert an electric signal into the sound wave audible to human, but also may convert the electric signal into the sound wave inaudible to the human for purposes such as ranging. In some embodiments, the audio circuit 1907 may further include an earphone jack. The power supply 1908 is configured to supply power to components in the terminal 1900. The power supply 1908 may be an alternating current, a direct current, a disposable battery, or a rechargeable battery. When the power supply 1908 includes the rechargeable battery, the rechargeable battery may be a wired rechargeable battery or a wireless rechargeable battery.

The wired rechargeable battery is a battery charged through a wired circuit, and the wireless rechargeable battery is a battery charged through a wireless coil. The rechargeable battery may be further configured to support a fast charging technology.

In some embodiments, the terminal 1900 further includes one or more sensors 1909. The one or more sensors 1909 include but are not limited to an acceleration sensor 1910, a gyroscope sensor 1911, a pressure sensor 1912, an optical sensor 1913, and a proximity sensor 1914.

The acceleration sensor 1910 may detect a magnitude of acceleration on three coordinate axes of a coordinate system established with the terminal 1900. For example, the acceleration sensor 1910 may be configured to detect components of gravity acceleration on the three coordinate axes. The processor 1901 may control the touch display screen 1905 to display a UI in a landscape view or a portrait view based on a gravity acceleration signal collected by the acceleration sensor 1910. The acceleration sensor 1910 may be further configured to collect movement data of a game or a user. The gyroscope sensor 1911 may detect a body direction and a rotation angle of the terminal 1900. The gyroscope sensor 1911 may cooperate with the acceleration sensor 1910 to collect a three-dimensional (3D) action performed by a user on the terminal 1900. The processor 1901 may implement the following functions based on the data collected by the gyroscope sensor 1911: motion sensing (for example, change of the UI based on a tilt operation of the user), image stabilization during photographing, game control, and inertial navigation. The pressure sensor 1912 may be arranged at a side frame of the terminal 1900 and/or a layer under the touch display screen 1905. When the pressure sensor 1912 is arranged at the side frame of the terminal 1900, a holding signal of the user on the terminal 1900 may be detected. The processor 1901 performs left/right hand recognition or a quick operation based on the holding signal acquired by the pressure sensor 1912. When the pressure sensor 1912 is arranged at the layer under the touch display screen 1905, the processor 1901 controls an operable control on the UI interface based on a pressure operation performed by a user on the touch display screen 1905. The operable control includes at least one of a button control, a scroll bar control, an icon control, or a menu control. The optical sensor 1913 is configured to collect ambient light intensity. In an embodiment, the processor 1901 may control display brightness of the touch display screen 1905 based on the ambient light intensity collected by the optical sensor 1913. Specifically, when the ambient light intensity is high, the display brightness of the touch display screen 1905 is increased; and when the ambient light intensity is low, the display brightness of the touch display screen 1905 is reduced. In another embodiment, the processor 1901 may further dynamically adjust a camera parameter of the camera component 1906 based on the ambient light intensity collected by the optical sensor 1913. The proximity sensor 1914, also referred to as a distance sensor, is usually arranged on the front panel of the terminal 1900. The proximity sensor 1914 is configured to collect a distance between the user and the front surface of the terminal 1900. In an embodiment, when the proximity sensor 1914 detects that the distance between the user and the front surface of the terminal 1900 is gradually smaller, the processor 1901 controls the touch display screen 1905 to be switched from a screen-on state to a screen-off state. When the proximity sensor 1914 detects that the distance between the user and the front surface of the terminal 1900 is gradually larger, the processor 1901 controls the touch display screen 1905 to be switched from the screen-off state to the screen-on state.

The above structures constitute no limitation on the terminal 1900, and the terminal may include more or fewer components than those shown in the figure, or some components may be combined, or a different component arrangement may be used.

In an exemplary embodiment, a chip is provided. The chip includes a programmable logic circuit and/or program instructions. When the chip runs on a computer device, the chip is configured to implement the method for summoning a virtual minion according to the foregoing aspects.

In an exemplary embodiment, a computer program product is further provided. The computer program product includes computer instructions. The computer instructions are stored in a computer-readable storage medium. A processor of a computer device reads the computer instructions from the computer-readable storage medium. The processor reads and executes the computer instructions from the computer-readable storage medium to implement the method for summoning a virtual minion according to the foregoing method embodiments.

In exemplary embodiments, a computer-readable storage medium is further provided. The computer-readable storage medium stores a computer program. The computer program is loaded and executed by a processor to implement the method for summoning a virtual minion according to the foregoing method embodiments.

A person of ordinary skill in the art may understand that all or part of the operations of implementing the foregoing embodiments may be implemented by hardware, or may be implemented by a program instructing related hardware. The program may be stored in a computer-readable storage medium. The foregoing storage medium may be a read only memory, a magnetic disk, an optical disc, or the like. A person skilled in the art may be aware that in the foregoing one or more examples, the functions in the embodiments of this application may be implemented by hardware, software, firmware, or any combination thereof. When implemented by using software, the functions may be stored in a computer-readable medium or may be used as one or more instructions or code in the computer-readable medium for transmission. The computer-readable medium includes a computer storage medium and a communication medium. The communication medium includes any medium that enables a computer program to be transmitted from one place to another. The storage medium may be any available medium accessible to a general purpose computer or a dedicated computer. The foregoing descriptions are merely exemplary embodiments of this application, and are not intended to limit this application. Any modification, equivalent replacement, or improvement made within the spirit and principle of this application shall fall within the protection scope of this application.

What is claimed is:

1. A method for summoning a virtual minion by a computer device, and the method comprising:
displaying, in a graphical user interface, a primarily controlled virtual character in a virtual environment and at least one element card;
in response to a selection operation for a first element card, generating a position cursor near a first position in the virtual environment, the first position being a summoning position of the virtual minion in the virtual environment;
in response to a trigger operation for the first element card, summoning the virtual minion at the first position in the virtual environment, an element attribute of the virtual minion being consistent with an element attribute identifier of the first element card; and
displaying an animation in which the primarily controlled virtual character throws out the first element card toward the first position in the virtual environment.

2. The method according to claim 1, wherein the generating the position cursor near the first position in the virtual environment comprises:
displaying the position cursor at an initial position in the virtual environment in response to a touch and hold operation for the first element card;
in response to a drag operation, moving the position cursor from the initial position to the first position in conjunction with the touch and hold operation; and
in response to a release operation for the first element card, summoning the virtual minion at the first position in the virtual environment.

3. The method according to claim 1, wherein the summoning the virtual minion at the first position in the virtual environment comprises:
displaying an entrance animation of the virtual minion at the first position in the virtual environment, the entrance animation and the element attribute identifier of the first element card having at least one identical material style; and
causing the virtual minion to perform a virtual activity in the virtual environment.

4. The method according to claim 3, wherein the element attribute of the virtual minion corresponding to the element attribute identifier comprises at least one of
a virtual electricity element attribute, a virtual fire element attribute, a virtual water element attribute, a virtual soil element attribute, a virtual metal element attribute, a virtual illumination element attribute, or a virtual dark element attribute.

5. The method according to claim 1, wherein the first position in the virtual environment is located at at least one of:
a central point of an observation picture of the virtual environment;
a moving direction or a facing direction of the primarily controlled virtual character, wherein the virtual minion has a virtual defense attribute for resisting a virtual attack;
a direction in which the primarily controlled virtual character points to a hostile virtual character, wherein the virtual minion has a virtual attack attribute for initiating a virtual attack;
in a direction in which the primarily controlled virtual character points to a point of interest marked in a virtual map, wherein the virtual minion has a virtual mount attribute for carrying the primarily controlled virtual character to move; or
a first virtual terrain, wherein the first virtual terrain has a gain effect on the first attribute of the virtual minion.

6. The method according to claim 1, further comprising:
changing a second element card in the at least one element card to be in a visually prominent state, the second element card satisfying a fusion condition;
in response to a fusion operation for the first element card and the second element card, fusing the first element card and the second element card into a third element card through fusion; and
in response to a trigger operation for the third element card, summoning a fused virtual minion at the first position in the virtual environment.

7. The method according to claim 6, wherein the fusing the first element card and the second element card into a third element card through fusion comprises:
in response to a moving operation for the first element card, generating the third element card through fusion when a distance between the first element card and the second element card does not exceed a distance threshold.

8. The method according to claim 6, wherein the second element card satisfying a fusion condition comprises at least one of:
no attribute restraint relationship exists between a first attribute corresponding to the first element card and a second attribute corresponding to the second element card;
a virtual volume difference between a virtual minion corresponding to the first element card and a virtual minion corresponding to the second element card does not exceed a volume difference threshold; or
a first virtual terrain where the primarily controlled virtual character is located has no impairment effect on the virtual minion corresponding to the second element card.

9. A computer device, comprising a processor and a memory, the memory having at least one program stored therein, and the processor being configured to execute the at least one program in the memory to implement a method for summoning a virtual minion including:
displaying, in a graphical user interface, a primarily controlled virtual character in a virtual environment and at least one element card;
in response to a selection operation for a first element card, generating a position cursor near a first position in the virtual environment, the first position being a summoning position of the virtual minion in the virtual environment;
in response to a trigger operation for the first element card, summoning the virtual minion at the first position in the virtual environment, an element attribute of the virtual minion being consistent with an element attribute identifier of the first element card; and
displaying an animation in which the primarily controlled virtual character throws out the first element card toward the first position in the virtual environment.

10. The computer device according to claim 9, wherein the generating the position cursor near the first position in the virtual environment comprises:
displaying the position cursor at an initial position in the virtual environment in response to a touch and hold operation for the first element card;
in response to a drag operation, moving the position cursor from the initial position to the first position in conjunction with the touch and hold operation; and
in response to a release operation for the first element card, summoning the virtual minion at the first position in the virtual environment.

11. The computer device according to claim 9, wherein the summoning the virtual minion at the first position in the virtual environment comprises:
displaying an entrance animation of the virtual minion at the first position in the virtual environment, the entrance animation and the element attribute identifier of the first element card having at least one identical material style; and
causing the virtual minion to perform a virtual activity in the virtual environment.

12. The computer device according to claim 11, wherein the element attribute of the virtual minion corresponding to the element attribute identifier comprises at least one of
a virtual electricity element attribute, a virtual fire element attribute, a virtual water element attribute, a virtual soil element attribute, a virtual metal element attribute, a virtual illumination element attribute, or a virtual dark element attribute.

13. The computer device according to claim 9, wherein the first position in the virtual environment is located at at least one of:
a central point of an observation picture of the virtual environment;
a moving direction or a facing direction of the primarily controlled virtual character, wherein the virtual minion has a virtual defense attribute for resisting a virtual attack;
a direction in which the primarily controlled virtual character points to a hostile virtual character, wherein the virtual minion has a virtual attack attribute for initiating a virtual attack;
in a direction in which the primarily controlled virtual character points to a point of interest marked in a virtual map, wherein the virtual minion has a virtual mount attribute for carrying the primarily controlled virtual character to move; or
a first virtual terrain, wherein the first virtual terrain has a gain effect on the first attribute of the virtual minion.

14. The computer device according to claim 9, wherein the method further comprises:
changing a second element card in the at least one element card to be in a visually prominent state, the second element card satisfying a fusion condition;
in response to a fusion operation for the first element card and the second element card, fusing the first element card and the second element card into a third element card through fusion; and
in response to a trigger operation for the third element card, summoning a fused virtual minion at the first position in the virtual environment.

15. The computer device according to claim 14, wherein the fusing the first element card and the second element card into a third element card through fusion comprises:
in response to a moving operation for the first element card, generating the third element card through fusion when a distance between the first element card and the second element card does not exceed a distance threshold.

16. The computer device according to claim 14, wherein the second element card satisfying a fusion condition comprises at least one of:
no attribute restraint relationship exists between a first attribute corresponding to the first element card and a second attribute corresponding to the second element card;
a virtual volume difference between a virtual minion corresponding to the first element card and a virtual minion corresponding to the second element card does not exceed a volume difference threshold; or
a first virtual terrain where the primarily controlled virtual character is located has no impairment effect on the virtual minion corresponding to the second element card.

17. A non-transitory computer-readable storage medium, having executable instructions stored therein, the executable instructions, when executed by a processor of a computer device, causing the computer device to implement a method for summoning a virtual minion including:
displaying, in a graphical user interface, a primarily controlled virtual character in a virtual environment and at least one element card;
in response to a selection operation for a first element card, generating a position cursor near a first position in the virtual environment, the first position being a summoning position of the virtual minion in the virtual environment;
in response to a trigger operation for the first element card, summoning the virtual minion at the first position in the virtual environment, an element attribute of the virtual minion being consistent with an element attribute identifier of the first element card; and
displaying an animation in which the primarily controlled virtual character throws out the first element card toward the first position in the virtual environment.

18. The non-transitory computer-readable storage medium according to claim 17, wherein the generating the position cursor near the first position in the virtual environment comprises:
displaying the position cursor at an initial position in the virtual environment in response to a touch and hold operation for the first element card;
in response to a drag operation, moving the position cursor from the initial position to the first position in conjunction with the touch and hold operation; and
in response to a release operation for the first element card, summoning the virtual minion at the first position in the virtual environment.

19. The non-transitory computer-readable storage medium according to claim 17, wherein the summoning the virtual minion at the first position in the virtual environment comprises:
displaying an entrance animation of the virtual minion at the first position in the virtual environment, the entrance animation and the element attribute identifier of the first element card having at least one identical material style; and
causing the virtual minion to perform a virtual activity in the virtual environment.

20. The non-transitory computer-readable storage medium according to claim 17, wherein the method further comprises:
changing a second element card in the at least one element card to be in a visually prominent state, the second element card satisfying a fusion condition;
in response to a fusion operation for the first element card and the second element card, fusing the first element card and the second element card into a third element card through fusion; and
in response to a trigger operation for the third element card, summoning a fused virtual minion at the first position in the virtual environment.
